(19) United States
(12) Patent Application Publication
(10) Pub. No.: US 2026/0113343 A1
(43) Pub. Date: Apr. 23, 2026

(54) SYSTEMS AND METHODS FOR DETECTING FRAUDULENT ACTIVITY ON CLOUD RESOURCES

(71) Applicant: Engineer.ai Corp., Salt Lake City, UT (US)

(72) Inventors: Sachin Dev Duggal, Salt Lake City, UT (US); Rohan Patel, London (GB); Waymond Chen, London (GB)

(73) Assignee: Engineer.ai Corp., Salt Lake City, UT (US)

(21) Appl. No.: 18/923,702

(22) Filed: Oct. 23, 2024

(51) Int. Cl. H04L 9/40; H04L 67/10

(52) U.S. Cl. CPC H04L 63/1425; H04L 67/10

(57) ABSTRACT

Systems, methods, and a computer readable storage medium are disclosed for detecting fraudulent activity on cloud resources. The method includes providing, through the cloud service platform, the cloud resources to one or more users and monitoring usage of the provided cloud resources. The method further includes identifying anomalies in the monitored usage based on predefined thresholds and suspending access to the provided cloud resources based on the identified anomalies.

### FIELD OF THE INVENTION

This disclosure relates to software automation, machine learning AI, and project management.

### BACKGROUND

Presently, cloud computing has changed the way individuals access and manage their computing resources in order to perform one or more computer-related tasks. Cloud service platforms provide virtual computing resources such as virtual machines, storage, and network services to the individual based on a request and requirements of the individual. However, the cloud service platforms may face challenges when the individual or any malicious user uses the provided computing resources to perform fraudulent activities. One such activity may be unauthorized cryptocurrency mining. Conventional methods of identifying fraudulent activities on cloud platforms generally involve manual monitoring and intervention, which are time-consuming and inefficient. Further, some of the fraudulent activities that employ advanced technologies may go undetected during manual monitoring.

Accordingly, there is a need in the art to provide a system and associated methods that can monitor resource usage and detect anomalies on the cloud service platform.

### SUMMARY

Disclosed are methods, systems, and computer readable storage mediums for detecting fraudulent activity on cloud resources. The method includes providing, through the cloud service platform, the cloud resources to one or more users and monitoring usage of the provided cloud resources. The method further includes identifying anomalies in the monitored usage based on predefined thresholds and suspending access to the provided cloud resources based on the identified anomalies.

### BRIEF DESCRIPTION OF THE DRAWINGS

FIG. 1 is a software building system illustrating the components that may be used in an embodiment of the disclosed subject matter.

FIG. 2 is a schematic illustrating an embodiment of the spec builder in accordance with a described implementation of the disclosed subject matter.

FIG. 3 is a schematic illustrating an embodiment of interactor in accordance with a described implementation of the disclosed subject matter.

FIG. 4 is a schematic illustrating an embodiment of the management components in accordance with a described implementation of the disclosed subject matter.

FIG. 5 is a schematic illustrating an embodiment of the expert evaluation system in accordance with a described implementation of the disclosed subject matter.

FIG. 6 is a schematic illustrating an embodiment of an assembly line and surfaces of the disclosed subject matter.

FIG. 7A is a schematic for an embodiment of a run engine of the disclosed subject matter.

FIG. 7B is a schematic for an embodiment of a building block that may be implemented in the disclosed subject matter.

FIG. 7C is a schematic for an embodiment of an adapter that may be implemented in the disclosed subject matter.

FIG. 8 is a schematic illustrating an embodiment of the run entities of the disclosed subject matter.

FIG. 9 is a schematic illustration of an example of an embodiment using a fraud detection system.

FIG. 10 is a schematic diagram of a fraud detection system in an embodiment of the disclosed subject matter.

FIG. 11 is a schematic illustration of computing resources usage during normal activity.

FIG. 12 is a schematic illustration of computing resources usage during unauthorized cryptocurrency mining activity.

FIG. 13 is a flow diagram for an embodiment of the disclosed subject matter for a process of detecting fraudulent activities on a cloud service platform.

FIG. 14 is a flow diagram for another embodiment of the disclosed subject matter for a process of detecting fraudulent activities on a cloud service platform.

FIG. 15 is a flow diagram for an embodiment of the disclosed subject matter for a process of preventing cryptocurrency mining fraud on a cloud service platform.

FIG. 16 is a schematic illustrating the computing components that may be used to implement various features of embodiments described in the disclosed subject matter.

FIG. 17 is a schematic illustration of an example of another embodiment using a fraud detection system.

FIG. 18 is a flow diagram for an embodiment of the disclosed subject matter for a process implemented by a fraud detection system.

### DETAILED DESCRIPTION

The disclosed subject matter is a method, system, and computer readable storage medium for detecting fraudulent activities on cloud resources provided by a cloud service platform. The disclosed fraud detection system is integrated with the cloud service platform and a database. The fraud detection system is designed to monitor and mitigate fraudulent activities on computing resources provided by the cloud service platform. The cloud service platform registers users and provides various cloud resources, such as virtual machines and storage, based on subscription plans. The database stores historical data, user profiles, and resource usage, which are utilized by the fraud detection system to train detection algorithms and monitor the resource usage.

The fraud detection system is a standalone system with several interconnected modules, including a cloud resource allocation module, a monitoring module, an anomaly detection module, and a report generation module. The cloud resource allocation module assigns computing resources to users based on their subscription plans. The monitoring module continuously tracks resource usage and detects patterns such as CPU, memory, and storage utilization, which is crucial for identifying unusual patterns that could indicate fraudulent activities. The anomaly detection module analyzes the monitored resource usage to detect anomalies by comparing it to baseline usage or predefined thresholds. These thresholds can vary based on time of day, day of the week, or user profiles. The system employs machine learning algorithms trained on historical data to improve anomaly detection accuracy. Detected anomalies could include excessive resource consumption, abnormal access patterns, or unauthorized activities like cryptocurrency mining.

Once anomalies are detected, the report generation module generates detailed reports, including the time and type of anomaly, affected resources, and user details. The reports also provide recommendations to mitigate identified anomalies and prevent future occurrences. The module can also execute actions, such as suspending or restricting access to cloud resources, based on the severity of the anomalies detected. User feedback on these actions helps re-train the machine learning algorithms for better accuracy.

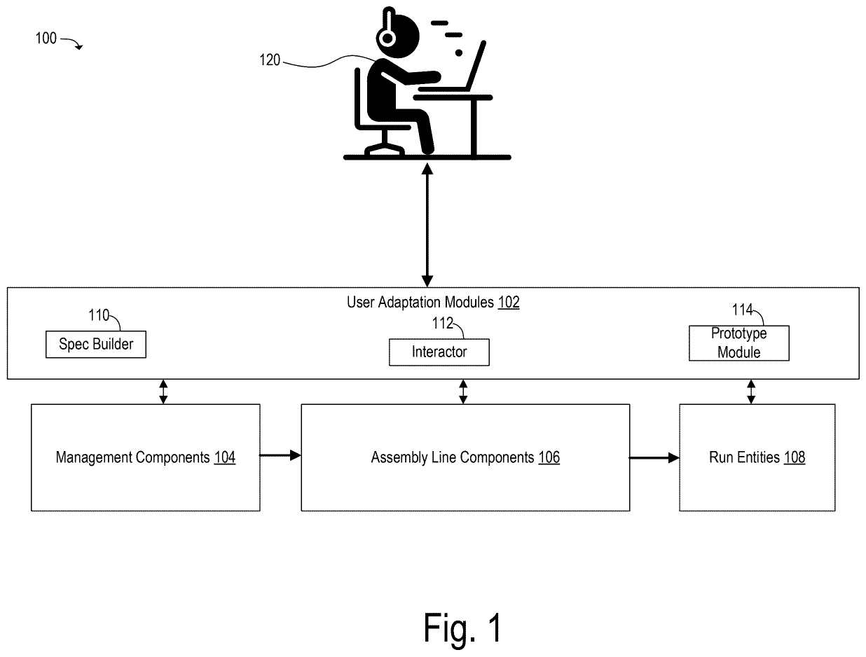

Referring to FIG. 1, FIG. 1 is a schematic of a software building system 100 illustrating the components that may be used in an embodiment of the disclosed subject matter. The software building system 100 is an AI-assisted platform that comprises entities, circuits, modules, and components that enable the use of state-of-the-art algorithms to support producing custom software.

A user 120 may leverage the various components of the software building system 100 to quickly design and complete a software project. The features of the software building system 100 operate AI algorithms where applicable to streamline the process of building software. Designing, building, and managing a software project may all be automated by the AI algorithms.

To begin a software project, an intelligent AI conversational assistant may guide users in the conception and design of their idea. Components of the software building system 100 may accept plain language specifications from a user 120 and convert them into a computer-readable specification that can be implemented by other parts of the software building system 100. Various other entities, modules, and components of the software building system 100 may accept the computer-readable specification or build card to automatically implement the computer-readable specification and/or manage the implementation of the computer-readable specification.

The embodiment of the software building system 100 shown in FIG. 1 includes user adaptation modules 102, management components 104, assembly line components 106, and run entities 108. The user adaptation modules 102 guide a user during all parts of a project from the idea conception to full implementation. User adaptation modules 102 may intelligently link a user to various entities of the software building system 100 based on the specific needs of the user.

The user adaptation modules 102 may include spec builder 110, an interactor 112 system, and the prototype module 114. They may be used to guide a user through the process of building software and managing a software project. Spec builder 110, the interactor 112 system, and the prototype module 114 may be used concurrently and/or linked to one another. For instance, spec builder 110 may accept user specifications that are generated in an interactor 112 system.

The prototype module 114 may utilize computer-generated specifications that are produced in spec builder 110 to create a prototype for various features. Further, the interactor 112 system may aid a user in implementing all features in spec builder 110 and the prototype module 114. The prototype module 114 may use a machine learning algorithm to select a most likely starting screen for each prototype. Thus, a user may select one or more features, and the prototype module 114 may automatically display a prototype of the selected features.

The prototype module 114 can automatically create an interactive prototype for features selected by a user. For instance, a user may select one or more features and view a prototype of one or more features before developing them. The prototype module 114 may determine feature links to which the user's selection of one or more features would be connected. In various embodiments, a machine learning algorithm may be employed to determine the feature links. The machine learning algorithm may further predict embeddings that may be placed in the user-selected features.

An example of the machine learning algorithm may be a gradient boosting model. A gradient boosting model may use successive decision trees to determine feature links. Each decision tree is a machine learning algorithm in itself and includes nodes that are connected via branches that branch based on a condition into two nodes. Input begins at one of the nodes whereby the decision tree propagates the input down a multitude of branches until it reaches an output node. The gradient boosted tree uses multiple decision trees in a series. Each successive tree is trained based on errors of the previous tree and the decision trees are weighted to return best results.

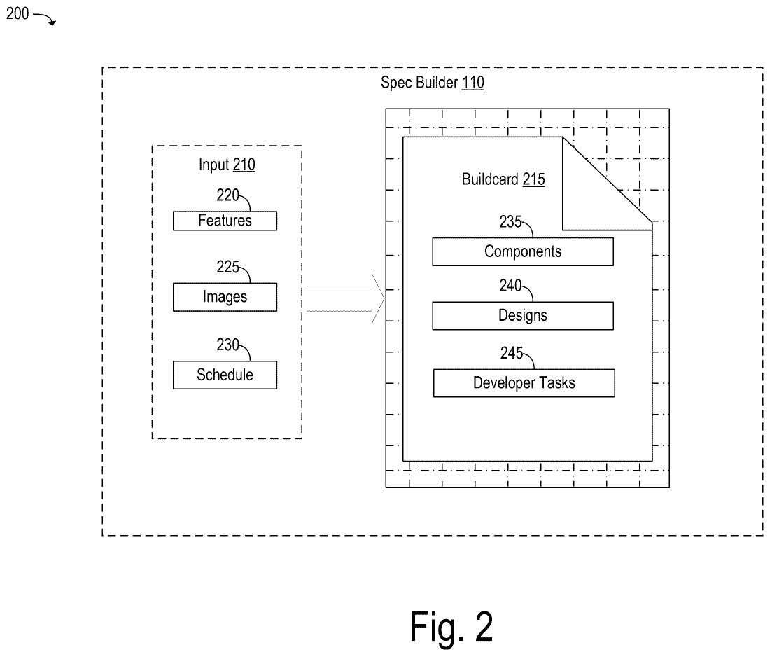

Referring to FIG. 2, FIG. 2 is a schematic 200 illustrating an embodiment of the spec builder 110 in accordance with a described implementation of the disclosed subject matter. Spec builder 110 converts input 210, such as user-supplied specifications, into specifications that can be automatically read and implemented by various objects, instances, or entities of the software building system 100. The machine-readable specification may be referred to herein as a buildcard 215. In an example of use, spec builder 110 may accept a set of features, platforms, etc., as input 210 and generate a machine-readable specification for that project.

Spec builder 110 may further use one or more machine learning algorithms to determine a cost and/or timeline for a given set of features. In an example of use, specification builder 110 may determine potential conflict points and factors that will significantly affect the cost and timeliness of a project based on training data. For example, historical data may show that a combination of various building block components creates a data transfer bottleneck. Spec builder 110 may be configured to flag such issues.

In an exemplary embodiment, a user may provide input 210, such as a plurality of features 220 to the spec builder 110. The spec builder 110 uses the features 220 to determine various components and designs 240 for a software application. For example, a user may provide that a software application should have a login feature. The spec builder 110 may determine that the login feature requires multiple components 235 and one or more designs 240 to implement the login feature.

The components 235 may comprise various functions, modules, classes, libraries, drivers, or the like that are used to code a software application. In various embodiments, the components 235 may comprise building block components as described below. The spec builder 110 may further generate one or more developer tasks 245 that would need to be completed to implement the login feature.

For example, one or more of the components 235 that were determined by the spec builder 110 may need to be custom built by a developer. One or more tasks will be generated by the spec builder to complete the one or more components 235 that need to be custom built. Each of these developer tasks 245 may be generated such that a skilled developer can read the developer task and follow it to build the component 235.

In various embodiments, each developer task may be written in such a way that an automated system may read the developer task 245 to develop the component 235 or design 240 for the software application. For example, the buildcard 215 may comprise a machine-readable specification and can be used as input for an automated system that generates components, designs, user interfaces, or the like for a software application based on the buildcard 215.

Likewise, the spec builder 110 may determine that one or more designs 240 should be implemented to complete the login feature. A design may comprise an organization of elements that are displayed on a screen for an end user. An end user, as described herein, may be an individual who is intended to use the completed software application. For example, a design for a login may comprise various screen elements that prompt an end user to enter a username and a password. The design 240 may specify any changes to a display as a software application is used. In the login feature example, the design 240 may determine what happens to a screen after an end user enters the username and password.

In various embodiments, a user may provide various images 225 to the spec builder 110. Spec builder 110 may leverage the images 225 to generate the designs 240. In an exemplary embodiment, a user may provide a sketch of various screens representing the user's vision of an operating software application. The spec builder 110 may generate designs 240 that approximate the user provided sketches.

In various embodiments, a user may provide a timeline or schedule 230 to the spec builder 110. The spec builder may use the schedule 230 to generate the developer tasks 245. In various embodiments, the spec builder 110 may split developer tasks 245 to accommodate a schedule 230. For example, a developer task that would normally be allocated to two developers, may be instead split among six developers to accommodate an aggressive schedule to develop a software application more quickly.

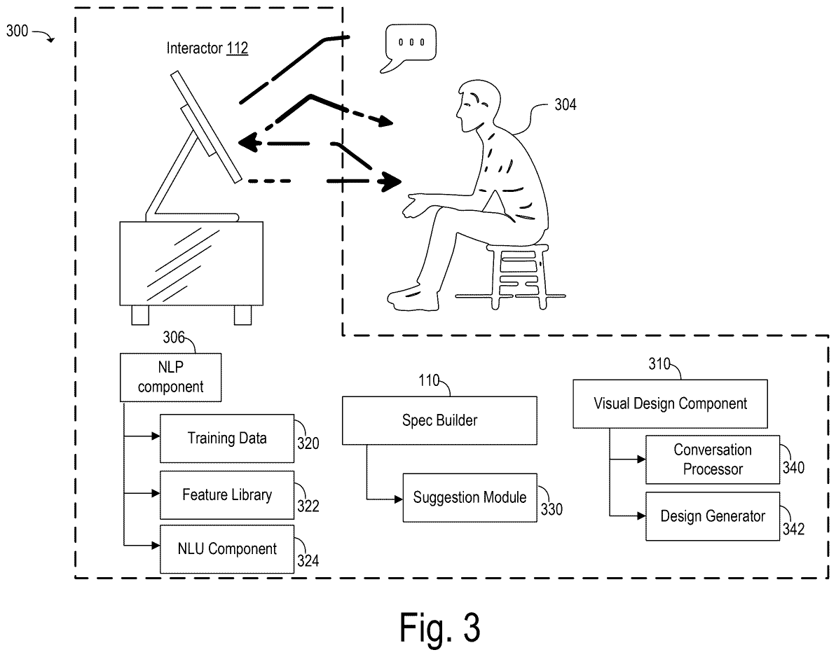

Referring to FIG. 3, FIG. 3 is a schematic 300 illustrating an embodiment of interactor 112 in accordance with a described implementation of the disclosed subject matter. The interactor 112 system is an AI powered speech and conversational analysis system. It converses with a user 304 with a goal of aiding the user 304. In one example, the interactor 112 system may ask the user 304 a question to prompt the user to answer about a relevant topic. For instance, the relevant topic may relate to a structure and/or scale of a software project the user wishes to produce. The interactor 112 system makes use of natural language processing (NLP) to decipher various forms of speech including comprehending words, phrases, and clusters of phases

In an exemplary embodiment, an NLP component 306 implemented by interactor 112 is based on a deep learning algorithm. Deep learning is a form of a neural network where nodes are organized into layers. A neural network has a layer of input nodes that accept input data where each of the input nodes are linked to nodes in a next layer. The next layer of nodes after the input layer may be an output layer or a hidden layer. The neural network may have any number of hidden layers that are organized in between the input layer and output layers.

Data propagates through a neural network beginning at a node in the input layer and traversing through synapses to nodes in each of the hidden layers and finally to an output layer. Each synapse passes the data through an activation function such as, but not limited to, a Sigmoid function. Further, each synapse has a weight that is determined by training the neural network. A common method of training a neural network is backpropagation.

Backpropagation is an algorithm used in neural networks to train models by adjusting the weights of the network to minimize the difference between predicted and actual outputs. During training, backpropagation works by propagating the error back through the network, layer by layer, and updating the weights in the opposite direction of the gradient of the loss function. By repeating this process over many iterations, the network gradually learns to produce more accurate outputs for a given input.

Various systems and entities of the software building system 100 may be based on a variation of a neural network or similar machine learning algorithm. For instance, input for NLP systems may be the words that are spoken in a sentence. In one example, each word may be assigned to separate input node where the node is selected based on the word order of the sentence. The words may be assigned various numerical values to represent word meaning whereby the numerical values propagate through the layers of the neural network.

The NLP component 306 employed by the interactor 112 system may output the meaning of words and phrases that are communicated by the user 304. The interactor 112 system may then use the NLP component 306 output to comprehend conversational phrases and sentences to determine the relevant information related to the user's goals of a software project. Further machine learning algorithms may be employed to determine what kind of project the user 304 wants to build including the goals of the user 304 as well as providing relevant options for the user 304.

In various embodiments, the neural network that comprises the NLP component 306 is trained with training data 320 based on previous software application projects. An example, the NLP component 306 is trained to identify features for software applications based on a description of the feature that is given by user 304. For example, a user may describe a communication system for a company where a computer receives communications from employee devices and transmits the communications appropriately to other employee devices where the communications are kept within the company. The NLP component 306 may identify the described functionality as a backend private messaging feature for a software application.

In various embodiments, the NLP component 306 has access to a feature library 322 that includes a multitude of completed components for software applications. The feature library may allow the software building system 100 to quickly include already-completed components in a software application without the need to write them from scratch. The NLP component 306 may be trained to identify components or designs from a feature library and suggest them to the user 304.

The NLP component 306 may include a natural language understanding (NLU) component 324. The NLU component 324 may allow the NLP component 306 to scan various documents and understand them. In one implementation, a user 304 may ask interactor 112 scan a multitude of documents as part of a description for what a software application will do.

In various embodiments, interactor 112 is coupled with spec builder 110 to generate machine-readable specifications or buildcards to develop software applications. In various embodiments, a user 304 may describe various features of a software application to interactor 112 and cause the spec builder 110 to generate a build card. The software building system 100 may determine a cost for the software developer project based on the build card and communicated to the user 304 via interactor 112. Interactor 112 may include a suggestion module 330 that suggests various modifications to the buildcard. In one implementation, the suggestion module 330 makes suggestions based on training data 320 from similar software development projects that have been completed.

In an exemplary embodiment, interactor 112 includes a visual design component 310. The visual design component 310 may be configured to generate one or more visual designs based on conversations that are recorded between interactor 112 and the user 304. The visual design component 310 may include a conversation processor 340 that logs a back-and-forth communication between the user 304 and interactor 112. The visual design component 310 may include a design generator 342 that determines one or more designs based on the log to conversation. In an exemplary embodiment, the design generator 342 generates designs based on training data 320 of conversations and designs from past software developed projects.

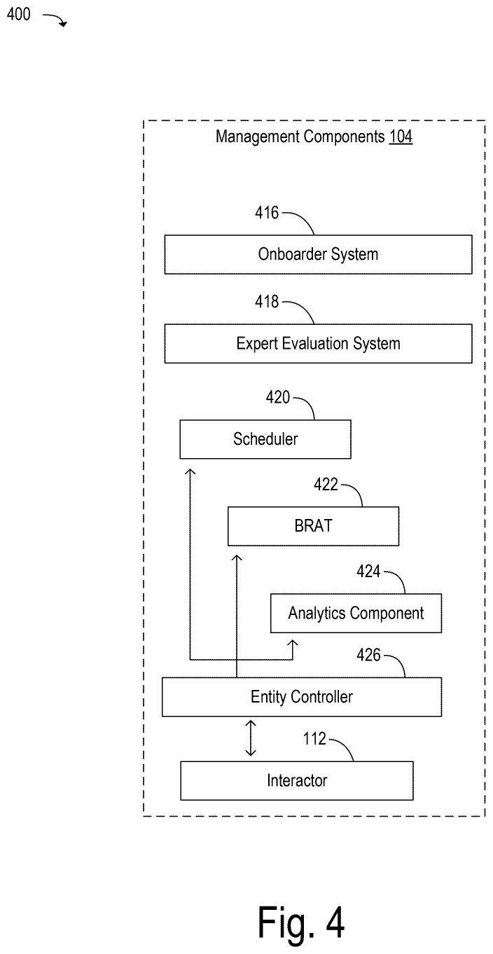

Referring to FIG. 4, FIG. 4 is a schematic 400 illustrating an embodiment of the management components 104 in accordance with a described implementation of the disclosed subject matter. The software building system 100 includes management components 104 that aid the user in managing a complex software building project. The management components 104 allow a user that does not have experience in managing software projects to effectively manage multiple experts in various fields. An embodiment of the management components 104 include the onboarding system 416, an expert evaluation system 418, scheduler 420, BRAT 422, analytics component 424, entity controller 426, and the interactor 112 system.

The onboarding system 416 aggregates experts so they can be utilized to execute specifications that are set up in the software building system 100. In an exemplary embodiment, software development experts may register into the onboarding system 416 which will organize experts according to their skills, experience, and past performance. In one example, the onboarding system 416 provides the following features: partner onboarding, expert onboarding, reviewer assessments, expert availability management, and expert task allocation.

An example of partner onboarding may be pairing a user with one or more partners in a project. The onboarding system 416 may prompt potential partners to complete a profile and may set up contracts between the prospective partners. An example of expert onboarding may be a systematic assessment of prospective experts including receiving a profile from the prospective expert, quizzing the prospective expert on their skill and experience, and facilitating courses for the expert to enroll and complete. An example of reviewer assessments may be for the onboarding system 416 to automatically review completed portions of a project. For instance, the onboarding system 416 may analyze submitted code, validate functionality of submitted code, and assess a status of the code repository. An example of expert availability management in the onboarding system 416 is to manage schedules for expert assignments and oversee expert compensation. An example of expert task allocation is to automatically assign jobs to experts that are onboarded in the onboarding system 416. For instance, the onboarding system 416 may determine a best fit to match onboarded experts with project goals and assign appropriate tasks to the determined experts.

The expert evaluation system 418 continuously evaluates developer experts. In an exemplary embodiment, the expert evaluation system 418 rates experts based on completed tasks and assigns scores to the experts. The scores may provide the experts with valuable critique and provide the onboarding system 416 with metrics with it can use to allocate the experts on future tasks.

Scheduler 420 keeps track of overall progress of a project and provides experts with job start and job completion estimates. In a complex project, some expert developers may be required to wait until parts of a project are completed before their tasks can begin. Thus, effective time allocation can improve expert developer management. Scheduler 420 provides up to date estimates to expert developers for job start and completion windows so they can better manage their own time and position them to complete their job on time with high quality.

The big resource allocation tool (BRAT 422) is capable of generating optimal developer assignments for every available parallel workstream across multiple projects. BRAT 422 system allows expert developers to be efficiently managed to minimize cost and time. In an exemplary embodiment, the BRAT 422 system considers a plethora of information including feature complexity, developer expertise, past developer experience, time zone, and project affinity to make assignments to expert developers. The BRAT 422 system may make use of the expert evaluation system 418 to determine the best experts for various assignments. Further, the expert evaluation system 418 may be leveraged to provide live grading to experts and employ qualitative and quantitative feedback. For instance, experts may be assigned a live score based on the number of jobs completed and the quality of jobs completed.

The analytics component 424 is a dashboard that provides a view of progress in a project. One of many purposes of the analytics component 424 dashboard is to provide a primary form of communication between a user and the project developers. Thus, offline communication, which can be time consuming and stressful, may be reduced. In an exemplary embodiment, the analytics component 424 dashboard may show live progress as a percentage feature along with releases, meetings, account settings, and ticket sections. Through the analytics component 424 dashboard, dependencies may be viewed and resolved by users or developer experts.

The entity controller 426 is a primary hub for entities of the software building system 100. It connects to scheduler 420, the BRAT 422 system, and the analytics component 424 to provide for continuous management of expert developer schedules, expert developer scoring for completed projects, and communication between expert developers and users. Through the entity controller 426, both expert developers and users may assess a project, make adjustments, and immediately communicate any changes to the rest of the development team.

The entity controller 426 may be linked to the interactor 112 system, allowing users to interact with a live project via an intelligent AI conversational system. Further, the interactor 112 system may provide expert developers with up-to-date management communication such as text, email, ticketing, and even voice communications to inform developers of expected progress and/or review of completed assignments.

The management components 104 provide for continuous assessment and management of a project through its entities and systems. The central hub of the management components 104 is entity controller 426. In an exemplary embodiment, core functionality of the entity controller 426 system comprises the following: display computer readable specifications configurations, provide statuses of all computer readable specifications, provide toolkits within each computer readable specification, integration of the entity controller 426 with tracker 646 and the onboarding system 416, integration code repository for repository creation, code infrastructure creation, code management, and expert management, customer management, team management, specification and demonstration call booking and management, and meetings management.

In an exemplary embodiment, the computer readable specification configuration status includes customer information, requirements, and selections. The statuses of all computer readable specifications may be displayed on the entity controller 426, which provides a concise perspective of the status of a software project. Toolkits provided in each computer readable specification allow expert developers and designers to chat, email, host meetings, and implement 3rd party integrations with users. The entity controller 426 allows a user to track progress through a variety of features including but not limited to tracker 646, the UI engine 642, and the onboarding system 416. For instance, the entity controller 426 may display the status of computer readable specifications as displayed in tracker 646. Further, the entity controller 426 may display a list of experts available through the onboarding system 416 at a given time as well as ranking experts for various jobs.

The entity controller 426 may also be configured to create code repositories. For example, the entity controller 426 may be configured to automatically create an infrastructure for code and to create a separate code repository for each branch of the infrastructure. Commits to the repository may also be managed by the entity controller 426.

Entity controller 426 may be integrated into scheduler 420 to determine a timeline for jobs to be completed by developer experts and designers. The BRAT 422 system may be leveraged to score and rank experts for jobs in scheduler 420. A user may interact with the various entity controller 426 features through the analytics component 424 dashboard. Alternatively, a user may interact with the entity controller 426 features via the interactive conversation in the interactor 112 system.

Entity controller 426 may facilitate user management such as scheduling meetings with expert developers and designers, documenting new software such as generating an API, and managing dependencies in a software project. Meetings may be scheduled with individual expert developers, designers, and with whole teams or portions of teams.

Machine learning algorithms may be implemented to automate resource allocation in the entity controller 426. In an exemplary embodiment, assignment of resources to groups may be determined by constrained optimization by minimizing total project cost. In various embodiments a health state of a project may be determined via probabilistic Bayesian reasoning whereby a causal impact of different factors on delays using a Bayesian network are estimated.

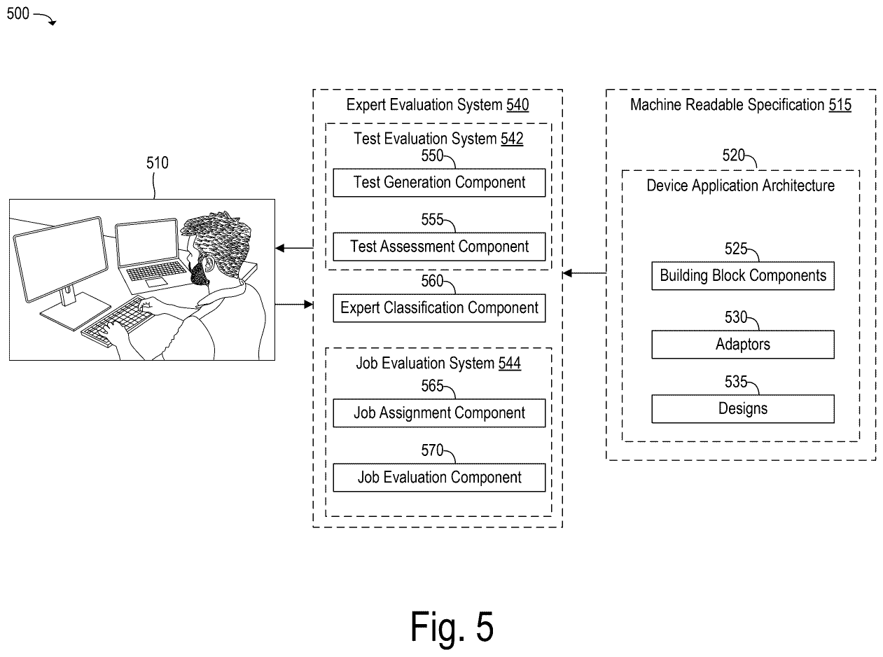

Referring to FIG. 5, FIG. 5 is a schematic 500 illustrating an embodiment of the expert evaluation system 540 in accordance with a described implementation of the disclosed subject matter. The developer 510 may be any individual that contributes to the development of a device application. The developer 510 may be a software developer, a designer, a quality engineer, or the like. The disclosed system may be used to classify one or more developers that are working on a device application. The classification may be used to assess the quality of work that employees are capable of performing. In various embodiments, the classification may be further used to match employees or developers to jobs that they are capable of performing.

In various embodiments, the disclosed subject matter may include a machine readable specification 515 for a device application. The machine-readable specification 515 may include information necessary to define one or more jobs that can be performed by the developer to contribute to the device application. For instance, the machine-readable specification 515 may include details necessary to build a building block component for the device application.

The disclosed system may include an expert evaluation system 540 that is capable of evaluating a developer 510 and evaluating jobs completed by the developer 510. In the exemplary embodiment shown in the schematic 500, the expert evaluation system 540 includes a test evaluation system 542, an expert classification component 560, and a job evaluation system 544.

The test evaluation system 542 may be used to test a developer 510 to determine the developer's 510 ability level. For instance, the test evaluation system 542 may give the developer 510 one or more tests for the developer to complete. Once completed, the test evaluation system 542 may grade the one or more tests to classify the developer 510. The test evaluation system 542 may include a test generation component 550 and a test assessment component 555. The test generation component 550 may be configured to generate one or more tests for the developer 510. In an exemplary embodiment, the test generation component 550 may generate one or more quizzes based on a developer's experience. The developer's experience may be determined based on a resume, an interview with the developer, or the like. An example of a quiz may be a test comprising one or more questions for which there is at least one correct answer. In addition to quizzes, the test generation component 550 may generate one or more assignments for the developer. An example of an assignment may be a task to complete a building block component. Another example of an assignment may be a task to design a user interface for a screen. Another example of a task may be to quality test a device application. An assignment for a developer that is a quality engineer may include conducting an analysis of a device application to identify defects or bugs in the device application. Another assignment for a developer that is a quality engineer may include making one or more improvements to a functionality of a device application or portion of a device application.

The test evaluation system 542 may transmit one or more quizzes or assignments that are generated by the test generation component 550 to the developer 510 for the developer to complete. Once completed, the developer 510 may transmit the completed quiz or assignment back to the test evaluation system 542. The test assessment component 555 may evaluate the completed quiz or assignment to determine a score or rank for the developer 510. For example, the test assessment component 555 may determine whether the developer 510 answered questions in the one or more quizzes correctly. In addition to grading quizzes, the test assessment component 555 may also evaluate assignments that are completed by the developer 510. For example, the test assessment component 555 may evaluate a completed assignment for various criteria to determine a score for the completed assignment. For instance, the test assessment component 555 may use a machine learning algorithm to evaluate a quality of an assignment to develop a software component or device application. An example of a machine learning algorithm is a neural network. In the example given above, the machine learning algorithm may evaluate a structure of the completed assignment to determine whether the structure conforms to standard industry practice. For instance, the machine learning algorithm may evaluate whether the developer 510 adhered to an entity component pattern that was called for in the assignment. The machine learning algorithm may further evaluate output based on various input for the completed assignment. For instance, if the assignment was to develop a component that accepts one or more user logins and sorts them into a database, the machine learning algorithm may test the completed component with one or more user logins to determine whether the completed assignment works properly.

The test assessment component 555 may generate a score that may be used by an expert classification component 560 to determine a classification or rank of the developer 510. The expert classification component 560 may use any combination of quiz scores and assignment scores to determine a classification for the developer 510. In various embodiments, the expert classification component 560 may weight one or more quizzes or assignments based on various criteria. For instance, the expert classification component 560 may weight a quiz that is related to a developers 510 expertise more than other quizzes or assignments. In another example, the expert classification component 560 may weight one or more quizzes or one or more assignments based on jobs that are available from the machine-readable specification 515. For instance, the expert classification component 560 may weight quizzes or assignments related to databases if there are pending jobs that require database work. A pending job may be a job that is yet to be completed. The term “pending machine readable specification”, as used herein, is a machine readable specification that includes one or more pending jobs.

The job evaluation system 544 transmits jobs to the developer 510 and assesses completed jobs that are received from the developer 510. In an exemplary embodiment, the job evaluation system 544 may include a job assignment component 565 and a job evaluation component 570. The job assignment component 565 may accept one or more jobs based on a machine-readable specification 515. In an exemplary embodiment, the machine-readable specification 515 may include one or more building block components 525, one or more adapters 530 that are designed to link the building block components 525, and one or more designs 535 for a device application. Additionally, the machine-readable specification 515 may include a device application architecture 520 that defines a structure for the building block components 525, the adapters 530, and designs 535.

One or more jobs may be resolved from the machine-readable specification 515. The jobs may be then passed by the job assessment component 565 to a developer 510 to be completed. Once completed, the developer 510 may transmit the completed job back to the job evaluation system 544. The job evaluation component 570 may assess the quality of the completed job. In an exemplary embodiment, the job evaluation component 570 comprises a machine learning algorithm that is configured to evaluate completed jobs. In various embodiments, different machine learning algorithms or models may be configured based on a type of job. For example, a machine learning algorithm may be configured to evaluate completed user interface components for device applications. For instance, a job to develop a building block component 525 that allows a user to select one or more items for purchase on a device application may be assigned to a developer 510. Once the job is completed, the job evaluation component 570 may evaluate the completed job using a machine learned algorithm that is trained to evaluate components related to user input.

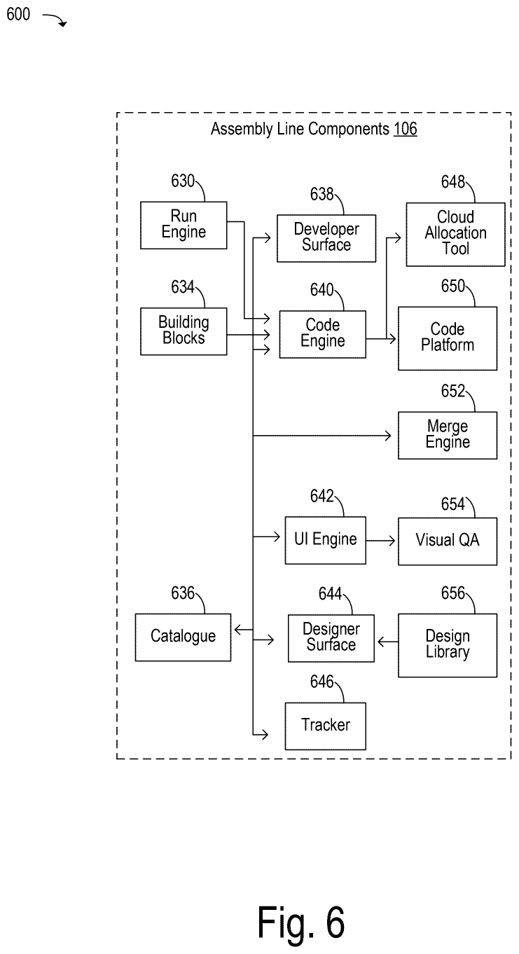

Referring to FIG. 6, FIG. 6 is a schematic 600 illustrating an embodiment of an assembly line and surfaces of the disclosed subject matter. The assembly line components 106 comprise underlying components that provide the functionality to the software building system 100. The embodiment of the assembly line components 106 includes a run engine 630, building block components 634, catalogue 636, developer surface 638, a code engine 640, a UI engine 642, a designer surface 644, tracker 646, a cloud allocation tool 648, a code platform 650, a merge engine 652, visual QA 654, and a design library 656.

The run engine 630 may maintain communication between various building block components within a project as well as outside of the project. In an exemplary embodiment, the run engine 630 may send HTTP/S GET or POST requests from one page to another.

The building block components 634 are reusable code that are used across multiple computer readable specifications. The term buildcards, as used herein, refer to machine readable specifications that are generated by specification builder 110, which may convert user specifications into a computer readable specification that contains the user specifications and a format that can be implemented by an automated process with minimal intervention by expert developers.

The computer readable specifications are constructed with building block components 634, which are reusable code components. The building block components 634 may be pretested code components that are modular and safe to use. In an exemplary embodiment, every building block component 634 consists of two sections—core and custom. Core sections comprise the lines of code which represent the main functionality and reusable components across computer readable specifications. The custom sections comprise the snippets of code that define customizations specific to the computer readable specification. This could include placeholder texts, theme, color, font, error messages, branding information, etc.

Catalogue 636 is a management tool that may be used as a backbone for applications of the software building system 100. In an exemplary embodiment, the catalogue 636 may be linked to the entity controller 426 and provide it with centralized, uniform communication between different services.

Developer surface 638 is a virtual desktop with preinstalled tools for development. Expert developers may connect to developer surface 638 to complete assigned tasks. In an exemplary embodiment, expert developers may connect to developer surface from any device connected to a network that can access the software project. For instance, developer experts may access developer surface 638 from a web browser on any device. Thus, the developer experts may essentially work from anywhere across geographic constraints. In various embodiments, the developer surface uses facial recognition to authenticate the developer expert at all times. In an example of use, all code that is typed by the developer expert is tagged with an authentication that is verified at the time each keystroke is made. Accordingly, if code is copied, the source of the copied code may be quickly determined. The developer surface 638 further provides a secure environment for developer experts to complete their assigned tasks.

The code engine 640 is a portion of a code platform 650 that assembles all the building block components required by the build card based on the features associated with the build card. The code platform 650 uses language-specific translators (LSTs) to generate code that follows a repeatable template. In various embodiments, the LSTs are pretested to be deployable and human understandable. The LSTs are configured to accept markers that identify the customization portion of a project. Changes may be automatically injected into the portions identified by the markers. Thus, a user may implement custom features while retaining product stability and reusability. In an example of use, new or updated features may be rolled out into an existing assembled project by adding the new or updated features to the marked portions of the LSTs.

In an exemplary embodiment, the LSTs are stateless and work in a scalable Kubernetes Job architecture which allows for limitless scaling that provide the needed throughput based on the volume of builds coming in through a queue system. This stateless architecture may also enable support for multiple languages in a plug & play manner.

The cloud allocation tool 648 manages cloud computing that is associated with computer readable specifications. For example, the cloud allocation tool 648 assesses computer readable specifications to predict a cost and resources to complete them. The cloud allocation tool 648 then creates cloud accounts based on the prediction and facilitates payments over the lifecycle of the computer readable specification.

The merge engine 652 is a tool that is responsible for automatically merging the design code with the functional code. The merge engine 652 consolidates styles and assets in one place allowing experts to easily customize and consume the generated code. The merge engine 652 may handle navigations that connect different screens within an application. It may also handle animations and any other interactions within a page.

The UI engine 642 is a design-to-code product that converts designs into browser ready code. In an exemplary embodiment, the UI engine 642 converts designs such as those made in Sketch into React code. The UI engine may be configured to scale generated UI code to various screen sizes without requiring modifications by developers. In an example of use, a design file may be uploaded by a developer expert to designer surface 644 whereby the UI engine automatically converts the design file into a browser ready format.

Visual QA 654 automates the process of comparing design files with actual generated screens and identifies visual differences between the two. Thus, screens generated by the UI engine 642 may be automatically validated by the visual QA 654 system. In various embodiments, a pixel to pixel comparison is performed using computer vision to identify discrepancies on the static page layout of the screen based on location, color contrast and geometrical diagnosis of elements on the screen. Differences may be logged as bugs by scheduler 420 so they can be reviewed by expert developers.

In an exemplary embodiment, visual QA 654 implements an optical character recognition (OCR) engine to detect and diagnose text position and spacing. Additional routines are then used to remove text elements before applying pixel-based diagnostics. At this latter stage, an approach based on similarity indices for computer vision is employed to check element position, detect missing/spurious objects in the UI and identify incorrect colors. Routines for content masking are also implemented to reduce the number of false positives associated with the presence of dynamic content in the UI such as dynamically changing text and/or images.

The visual QA 654 system may be used for computer vision, detecting discrepancies between developed screens, and designs using structural similarity indices. It may also be used for excluding dynamic content based on masking and removing text based on optical character recognition whereby text is removed before running pixel-based diagnostics to reduce the structural complexity of the input images.

The designer surface 644 connects designers to a project network to view all of their assigned tasks as well as create or submit customer designs. In various embodiments, computer readable specifications include prompts to insert designs. Based on the computer readable specification, the designer surface 644 informs designers of designs that are expected of them and provides for easy submission of designs to the computer readable specification. Submitted designs may be immediately available for further customization by expert developers that are connected to a project network.

Similar to building block components 634, the design library 656 contains design components that may be reused across multiple computer readable specifications. The design components in the design library 656 may be configured to be inserted into computer readable specifications, which allows designers and expert developers to easily edit them as a starting point for new designs. The design library 656 may be linked to the designer surface 644, thus allowing designers to quickly browse pretested designs for user and/or editing.

Tracker 646 is a task management tool for tracking and managing granular tasks performed by experts in a project network. In an example of use, common tasks are injected into tracker 646 at the beginning of a project. In various embodiments, the common tasks are determined based on prior projects, completed, and tracked in the software building system 100.

The assembly line components 106 support the various features of the management components 104. For instance, the code platform 650 is configured to facilitate user management of a software project. The code engine 640 allows users to manage the creation of software by standardizing all code with pretested building block components. The building block components contain LSTs that identify the customizable portions of the building block components 634.

The machine readable specifications may be generated from user specifications. Like the building block components, the computer readable specifications are designed to be managed by a user without software management experience. The computer readable specifications specify project goals that may be implemented automatically. For instance, the computer readable specifications may specify one or more goals that require expert developers. The scheduler 420 may allocate the expert developers based on the computer readable specifications or with direction from the user. Similarly, one or more designers may be hired based on specifications in a computer readable specification. Users may actively participate in management or take a passive role.

A cloud allocation tool 648 is used to determine costs for each computer readable specification. In an exemplary embodiment, a machine learning algorithm is used to assess computer readable specifications to estimate costs of development and design that is specified in a computer readable specification. Cost data from past projects may be used to train one or more models to predict costs of a project.

The developer surface 638 system provides an easy to set up platform within which expert developers can work on a software project. For instance, a developer in any geography may connect to a project via the cloud system 862 and immediately access tools to generate code. In one example, the expert developer is provided with a preconfigured IDE as they sign into a project from a web browser.

The designer surface 644 provides a centralized platform for designers to view their assignments and submit designs. Design assignments may be specified in computer readable specifications. Thus, designers may be hired and provided with instructions to complete a design by an automated system that reads a computer readable specification and hires out designers based on the specifications in the computer readable specification. Designers may have access to pretested design components from a design library 656. The design components, like building block components, allow the designers to start a design from a standardized design that is already functional.

The UI engine 642 may automatically convert designs into web ready code such as React code that may be viewed by a web browser. To ensure that the conversion process is accurate, the visual QA 654 system may evaluate screens generated by the UI engine 642 by comparing them with the designs that the screens are based on. In an exemplary embodiment, the visual QA 654 system does a pixel to pixel comparison and logs any discrepancies to be evaluated by an expert developer.

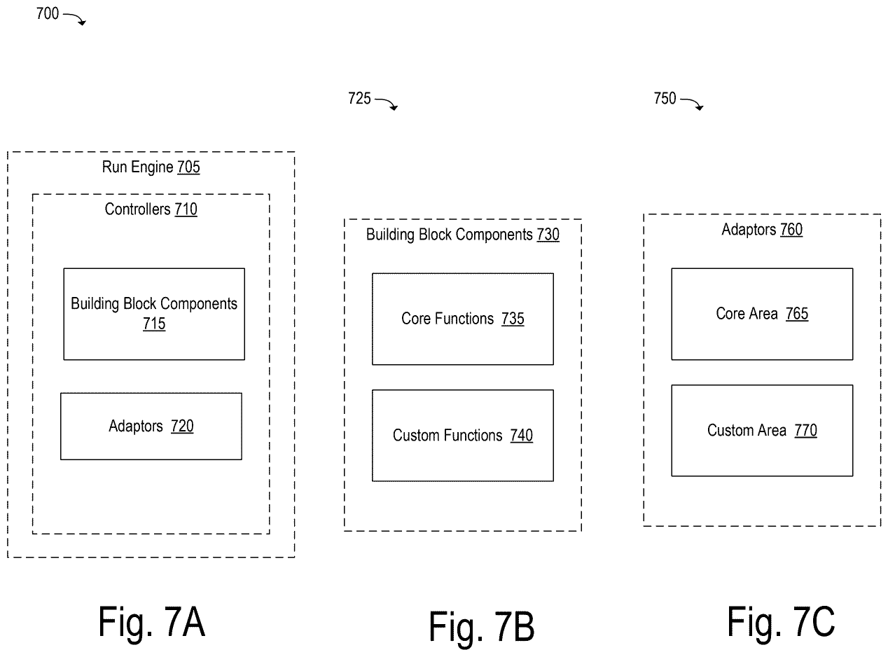

Referring to FIG. 7A, FIG. 7A is a schematic 700 for an embodiment of a run engine 705 of the disclosed subject matter. The run engine 705 facilitates the transmission of messages within the software application. Building block components 715 that make up core features of a software application are operated by the run engine 705. In various embodiments, a developer may select a multitude of building block components 715 depending on features that are desired for the software application. The run engine 705 may contain any number of building block components 715 to implement any number of features.

In an exemplary embodiment, the run engine 705 comprises one or more controllers 710. Each controller 710 may comprise one or more building block components 715 and one or more adapters 720. The controller 710 may include logic that determines an interaction between building block components 715. For instance, a controller 710 may comprise a building block component 715 that includes the functions for logging a user into a server. Logic in the controller 710 may determine when those functions are implemented. Logic in the controller may also help determine one or more functions that are implemented after the login is implemented.

The building block components 715 are software modules that comprise one or more functions for implementing features in a software application. Each building block component 715 in the controller 710 may operate independently of each other building block component 715 in the controller 710. Accordingly, removing or adding one or more building block components 715 from the controller 710 or from the software application does not impact a functionality of the other building block components 715 in the software application or controller 710. Building block components 715 may be developed in any order or in parallel in a software application. For instance, multiple developers may concurrently develop one or more building block components 715 for the same software application.

The controller 710 may include one or more adapters 720 that enable the sending and receiving of messages to and from building block components 715. Building block components 715 may communicate with other building block components 715 via the sending of messages. Adapters 720 may be used to generate messages based on output from a building block component 715. Adapters 720 may also be used to receive messages for one or more building block components 715. A single adapter 720 may be implemented to send and receive messages for one or more building block components 715.

In an example of use, when a building block component 715, which is configured to log a user into an application, completes a login, an adapter 720 may be configured to broadcast a message that a login is complete. Another building block component 715, which is configured to open a startup screen may be activated based on the login complete message. Accordingly, an adapter may receive the login complete message and activate a building block component 715 to open the start of screen.

Referring to FIG. 7B, FIG. 7B is a schematic 725 for an embodiment of a building block component 730 that may be implemented in the disclosed subject matter. A software application may include one or more building block components 730. Each building block component 730 operates independently of the other building block components 730, but may be configured to send and receive messages to and from the other building block components 730.

Each building block component 730 comprises software functions that enable one or more features in the software application. For instance, a building block component 730 for implementing a clickable button may include one or more functions, that when executed, implement a clickable button utility. Each building block component 730 may comprise one or more core functions 735 and one or more custom functions 740. The core functions 735 may be configured to be un-editable in a building block component 730. A developer may be encouraged to include one or more custom functions 740 in a building block component 730 to implement functionality or features that are specific to their software application.

Each of the core functions 735 and custom functions 740 may be configured so as not to depend on functionality from other building block components 730. Thus, each of the building block components 730 may be developed independently. This may allow for rapid development as building block components 730 may be developed concurrently by multiple developers. Further, building block components 730 may be configured to implement specific features in an application that are common to multiple applications.

Thus, a single building block component 730 may be developed to be used as a utility. A developer may choose to include a preconfigured building block component 730 based on features that the developer desires in the software application. A completed software application may be further developed by adding additional building block components 730 because the additional building block components 730 do not depend on any of the existing building block components 730. Further, adding additional building blocks to a software application will not break any of the functionality of the software application.

Referring to FIG. 7C, FIG. 7C is a schematic 750 for an embodiment of an adapter 760 that may be implemented in the disclosed subject matter. Building block components 730 may be configured not to depend on any functions of other building block components 730. However, a building block component may be configured to receive messages that are generated by another building block component 730. The transmission of messages from one building block component 730 to another is facilitated by the adapters 760.

Adapters 760 allow for building block components 730 to be interconnected without being interdependent on functionality. A building block component 730 may generate a message that is to be received by another building block component 730. An adapter 760 may be configured to broadcast a message from one building block component 730 and another adapter 760 may be configured to listen for the message. For example, the adapter 760 may be configured to subscribe to one or more messages, where subscribing puts the adapter in a state that causes the adapter 760 to perform an action when it receives the message. The terms listening and subscribing, as used herein, are used interchangeably as they apply to the adapters 760.

In various embodiments, an adapter may be configured to broadcast data that is nested in a message. For instance, an adapter may broadcast a message to open a checkout screen for a shopping application. The message to open the checkout screen may be received by an adapter 760 that executes one or more functions on a building block component 634 that operates the checkout screen. The message may further include nested data such as one or more shopping items that the user selected. The nested data may be received by the adapter 760 along with the message to be transmitted to the building block component 730 that implements the checkout screen.

Like building block components 730, the adapters 760 may each include a core area 765 and a custom area 770. The core area 765 may include one or more functions that facilitate sending and receiving messages with the adapter 760. In various embodiments, an adapter may have a listen function whereby any adapter may be configured to listen for one or more messages that may be transmitted within the run engine 705. In an example of use, an adapter 760 is configured to listen for a “LOGIN_COMPLETE” message. When the adapter 760 receives the “LOGIN_COMPLETE” message, it executes one or more functions in a building block component 730.

The custom area 770 in each adapter 760 may be utilized to implement logic in a software application. For example, the custom area may be edited to execute one or more functions of a building block upon receiving a message from the run engine 705. In another example, logic may be implemented to broadcast one or more messages responsive to execution of functions in a building block component 730.

In various embodiments, the customer logic area may be configurable by a machine readable specification. For example, a machine readable specification may specify that execution of a function by a first building block component triggers execution of a function by a second building block component. Accordingly, a computer system may automatically insert logic into a first adapter that causes the adapter to transmit a message responsive to the first building block component executing the function. The machine readable specification may further insert logic into a second adapter that causes the second adapter to listen for the message and cause the second building block component to execute a function responsive to receiving the message.

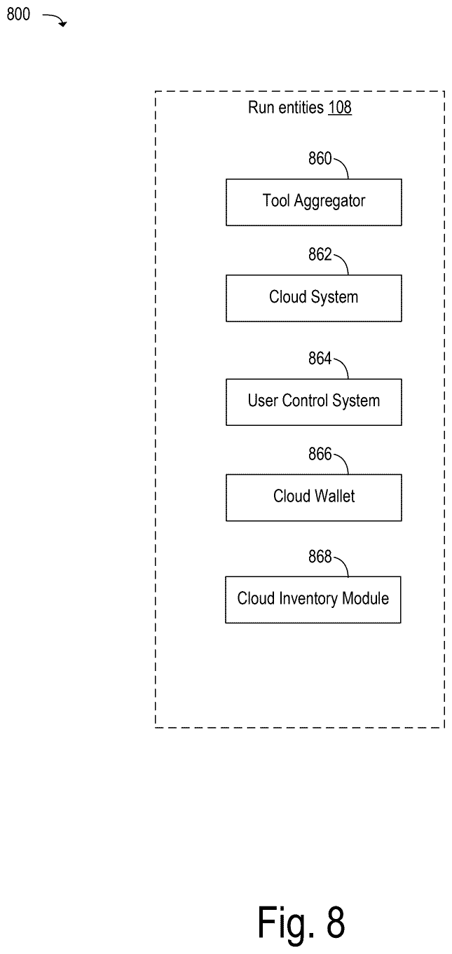

Referring to FIG. 8, FIG. 8 is a schematic 800 illustrating an embodiment of the run entities 108 of the disclosed subject matter. The run entities 108 contain entities that all users, partners, expert developers, and designers use to interact within a centralized project network. In an exemplary embodiment, the run entities 108 include tool aggregator 860, cloud system 862, user control system 864, cloud wallet 866, and a cloud inventory module 868. The tool aggregator 860 entity brings together all third-party tools and services required by users to build, run and scale their software project. For instance, it may aggregate software services from payment gateways and licenses such as Office 365. User accounts may be automatically provisioned for needed services without the hassle of integrating them one at a time. In an exemplary embodiment, users of the run entities 108 may choose from various services on demand to be integrated into their application. The run entities 108 may also automatically handle invoicing of the services for the user.

The cloud system 862 is a cloud platform that is capable of running any of the services in a software project. The cloud system 862 may connect any of the entities of the software building system 100 such as the code platform 650, developer surface 638, designer surface 644, catalogue 636, entity controller 426, spec builder 110, the interactor 112 system, and the prototype module 114 to users, expert developers, and designers via a cloud network. In one example, cloud system 862 may connect developer experts to an IDE and design software for designers allowing them to work on a software project from any device.

The user control system 864 is a system requiring the user to have input over every feature of a final product in a software product. With the user control system 864, automation is configured to allow the user to edit and modify any features that are attached to a software project regardless as to the coding and design by developer experts and designer. For example, building block components 634 are configured to be malleable such that any customizations by expert developers can be undone without breaking the rest of a project. Thus, dependencies are configured so that no one feature locks out or restricts development of other features.

Cloud wallet 866 is a feature that handles transactions between various individuals and/or groups that work on a software project. For instance, payment for work performed by developer experts or designers from a user is facilitated by cloud wallet 866. A user need only set up a single account in cloud wallet 866 whereby cloud wallet handles payments of all transactions.

A cloud allocation tool 648 may automatically predict cloud costs that would be incurred by a computer readable specification. This is achieved by consuming data from multiple cloud providers and converting it to domain specific language, which allows the cloud allocation tool 648 to predict infrastructure blueprints for customers' computer readable specifications in a cloud agnostic manner. It manages the infrastructure for the entire lifecycle of the computer readable specification (from development to after care) which includes creation of cloud accounts, in predicted cloud providers, along with setting up CI/CD to facilitate automated deployments.

The cloud inventory module 868 handles storage of assets on the run entities 108. For instance, building block components 634 and assets of the design library are stored in the cloud inventory entity. Expert developers and designers that are onboarded by onboarding system 416 may have profiles stored in the cloud inventory module 868. Further, the cloud inventory module 868 may store funds that are managed by the cloud wallet 866. The cloud inventory module 868 may store various software packages that are used by users, expert developers, and designers to produce a software product.

The run entities 108 provides a user with 3^{rd} party tools and services, inventory management, and cloud services in a scalable system that can be automated to manage a software project. In an exemplary embodiment, the run entities 108 is a cloud-based system that provides a user with all tools necessary to run a project in a cloud environment.

For instance, the tool aggregator 860 automatically subscribes with appropriate 3^{rd} party tools and services and makes them available to a user without a time consuming and potentially confusing set up. The cloud system 862 connects a user to any of the features and services of the software project through a remote terminal. Through the cloud system 862, a user may use the user control system 864 to manage all aspects of a software project including conversing with an intelligent AI in the interactor 112 system, providing user specifications that are converted into computer readable specifications, providing user designs, viewing code, editing code, editing designs, interacting with expert developers and designers, interacting with partners, managing costs, and paying contractors.

A user may handle all costs and payments of a software project through cloud wallet 866. Payments to contractors such as expert developers and designers may be handled through one or more accounts in cloud wallet 866. The automated systems that assess completion of projects such as tracker 646 may automatically determine when jobs are completed and initiate appropriate payment as a result. Thus, accounting through cloud wallet 866 may be at least partially automated. In an exemplary embodiment, payments through cloud wallet 866 are completed by a machine learning AI that assesses job completion and total payment for contractors and/or employees in a software project.

Cloud inventory module 868 automatically manages inventory and purchases without human involvement. For example, cloud inventory module 868 manages storage of data in a repository or data warehouse. In an exemplary embodiment, it uses a modified version of the knapsack algorithm to recommend commitments to data that it stores in the data warehouse. Cloud inventory module 868 further automates and manages cloud reservations such as the tools providing in the tool aggregator 860.

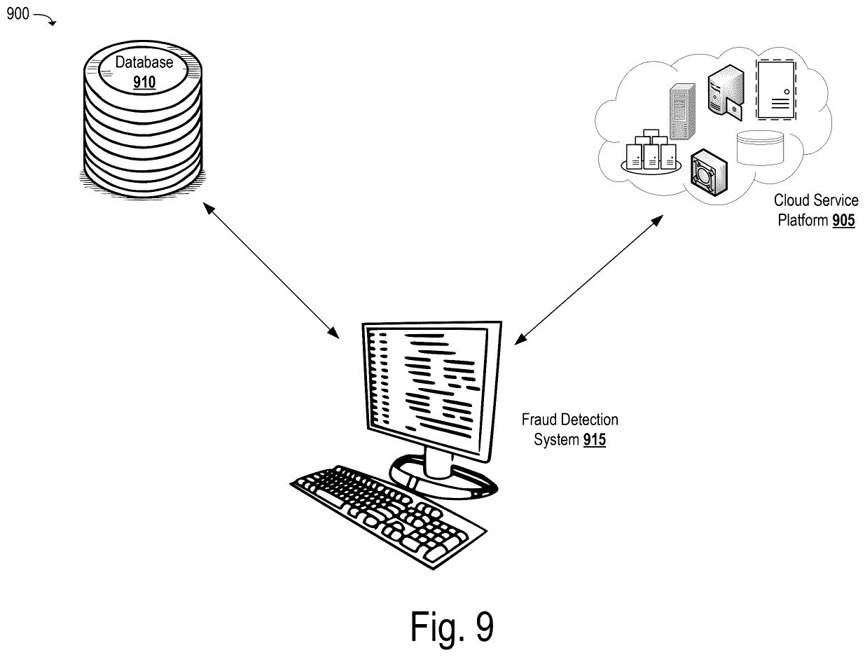

Referring to FIG. 9, FIG. 9 is a schematic illustration of an example of an embodiment using a fraud detection system. The illustration 900 describes a schematic representation of a cloud service platform 905, a database 910, the fraud detection system 915, and the interaction between the cloud service platform 905, the database 910, and the fraud detection system 915. The illustration shows how the fraud detection system 915 interacts with different devices (such as the cloud service platform 905 and the database 910) to detect and mitigate one or more fraudulent activities on one or more computing resources provided by the cloud service platform 905.

The cloud service platform 905 is configured to register one or more users and provide computing resources, also known as cloud resources, to the one or more registered users. In some embodiments, the computing resources are provided based on a subscription plan selected by the one or more users upon registering to the cloud service platform 905. In some embodiments, the computing resources may comprise virtual machines, storage, network services, or the like. For example, when an admin user hosts an e-commerce software application, the admin user may need storage to store user profiles of users registered with the e-commerce software application, one or more user preferences, and any other relevant information. Accordingly, the admin user may register with the cloud service platform and purchase the computing resources required for the software application.

The database 910 is coupled to the cloud service platform 905 and serves as a central repository. The database 910 is configured to store historical data, user profiles, and resource usage of the registered users. Further, the database 910 is also configured to store a user limit associated with each of the one or more resources. In some embodiments, information stored in the database 910 may be utilized by one or more systems, such as the fraud detection system 915, to train one or more detection algorithms employed by the fraud detection system 915. In some embodiments, the database 910 may be part of the cloud resource platform 905. In some other embodiments, the database 910 may be part of the fraud detection system 915.

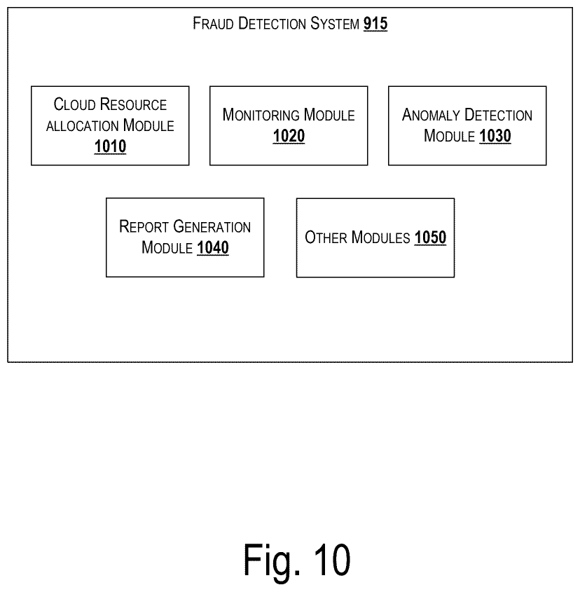

The fraud detection system 915 is coupled to the cloud service platform 905 and the database 910. The fraud detection system, as discussed in detail in FIG. 10, is configured to continuously monitor one or more computing resources provided by the cloud service platform 905 to one or more users, analyze the usage of the one or more computing resources to detect any fraudulent activity, and revoke access to the one or more computing resources to the one or more users based on the analysis.

Referring to FIG. 10, FIG. 10 is a schematic diagram of the fraud detection system 915 in an embodiment of the disclosed subject matter. In some exemplary embodiments, the fraud detection system 915 is configured to detect fraudulent activities on computing resources provided by the cloud service platform 905.

In some embodiments, the fraud detection system 915 may be configured as a standalone system. The fraud detection system 915 comprises one or more components coupled with each other that may be deployed on a single system or different systems. In some embodiments, the fraud detection system 915 comprises a cloud resource allocation module 1010, a monitoring module 1020, an anomaly detection module 1030, a report generation module 1040, and other modules 1050. Each of the cloud resource allocation module 1010, the monitoring module 1020, the anomaly detection module 1030, and the report generation module 1040 is configured to perform a specific function for fulfilling the functionality of the fraud detection system 915.

As used herein, the term module refers to an application-specific integrated circuit (ASIC), an electronic circuit, a processor (shared, dedicated, or group) and memory that execute one or more software or firmware programs, a combinational logic circuit, and/or other suitable components that provide the described functionality. In some embodiments, the other modules 1050 may be used to perform various miscellaneous functionalities of the fraud detection system 915. It will be appreciated that such modules 1050 may be represented as a single module or a combination of different modules.

The fraud detection system 915 comprises the cloud resource allocation module 1010. The cloud resource allocation module 1010 is configured to receive a request from one or more users and allocate the computing resources to the one or more users based on the subscription level and request from the one or more users. In some embodiments, the computing resources may comprise virtual machines, storage, network services, or the like. For example, when a user hosts an email software application, the admin user may need storage to store user profiles of users registered and also emails received by each user. Accordingly, the cloud resource allocation module 1010 allocates the computing resources upon receiving the request from the admin user.

The fraud detection system 915 also comprises the monitoring module 1020 which is coupled to the cloud resource allocation module 1010. The monitoring module 1020 is configured to continuously monitor the cloud resource usage upon the computing resources allocated to the one or more users. In some embodiments, the monitored cloud resource usage comprises CPU usage, memory usage, network bandwidth, and storage utilization. In some embodiments, the monitoring module 1020 is also configured to detect resource usage pattern based on the monitored cloud resource usage. For example, the user may subscribe to a cloud resource of 1 TB of data storage and may upload data of 100 MB every day. Thus, by monitoring the cloud resource usage, the pattern of usage, in this case uploading data for 100 MB, is detected.

The fraud detection system 915 further comprises the anomaly detection module 1030 which is coupled to the monitoring module 1020. The anomaly detection module 1030 is a central component of the fraud detection system 915. The anomaly detection module 1030 is configured to analyze the monitored cloud resource usage associated with the one or more users. In some embodiments, the anomaly detection module 1030 is configured to detect one or more anomalies in the cloud resource usage based on the analysis of the monitored cloud resource usage. In some embodiments, in order to detect the one or more anomalies, the anomaly detection module 1030 is configured to compare the monitored cloud resource usage against a baseline usage and detect the one or more anomalies based on the comparison. For example, the baseline usage may specify usage of 1 GB of cloud storage and if the monitored cloud resource usage is 2 GB, it may be detected as an anomaly.

In some embodiments, the anomaly detection module 1030 is configured to identify the one or more anomalies in the monitored cloud resource usage based on predefined thresholds. The predefined threshold may be adjusted based on time of day, day of week, and customer usage profiles. For example, the predefined threshold of cloud storage may be 1 GB of cloud storage for normal working hours and may be adjusted to 500 MB after normal working hours. Similarly, the predefined threshold may be 1 GB of cloud storage for any user registered with the cloud service platform 905, whereas for one or more employees of the cloud service platform, the predefined threshold may be 100 GB of cloud storage. In some embodiments, the anomaly detection module 1030 may employ one or more machine learning algorithms trained using historical data to resource usage patterns to detect the one or more anomalies.

In some embodiments, the one or more anomalies may comprise fraudulent activities on the computing resources allocated. Further, the fraudulent activities may comprise unauthorized cryptocurrency mining activities on the computing resource allocated. In some other embodiments, the one or more anomalies may comprise excessive resource consumption and abnormal access pattern. Unauthorized cryptocurrency mining activity refers to an illicit utilization of computational power and resources of the cloud service platform 905 to perform cryptocurrency mining without the approval of the rightful owner of the cloud service platform 905. The unauthorized cryptocurrency mining activity generally happens when mining software is deployed on the virtual machines (VMs) or other computing instances provided by the cloud service platform 905, thereby leading to excessive and unexpected consumption of processing power, electricity, and network bandwidth, and also resulting in substantial financial and operational costs for the cloud service platform 905.

The fraud detection system 915 further comprises the report generation module 1040 which is coupled to the anomaly detection module 1030. The report generation module 1040 is configured to generate one or more reports based on the identified one or more anomalies. In some embodiments, the generated report provides details such as the time of occurrence of the identified anomaly, type of anomaly, affected computing resources due to the identified anomaly, and the user identification number using the computing resource when the anomaly is identified. In some embodiments, the report also comprises recommendations for mitigating the identified anomalies and for preventing future occurrences of the identified anomalies. For example, the recommendation may be to use multi-factor authentication (MFA) for all user accounts, thereby preventing malicious actors from easily exploiting the cloud resources for unauthorized activities such as cryptocurrency mining.

Further, in some embodiments, the report generation module 1040 is also configured to execute one or more actions based on the identified anomalies. In some embodiments, executing the one or more actions may comprise suspending access to cloud resources provided to the one or more users based on the identified anomalies. In some embodiments, executing the one or more actions may comprise restricting an access to the cloud resources provided to one or more users based on the identified anomalies. In some embodiments, the generated report may be related to identified unauthorized cryptocurrency mining activity that comprises the time of occurrence of the unauthorized cryptocurrency mining activity, affected computing resources due to the unauthorized cryptocurrency mining activity, and the user identification number using the computing resource when the unauthorized cryptocurrency mining activity is identified.

Furthermore, in some exemplary embodiments, the report generation module 1040 is configured to receive inputs from the one or more users to revoke the executed one or more actions. In some embodiments, the inputs also comprise justification for the identified anomaly. In some embodiments, the inputs may be utilized as feedback to improve the accuracy of identification of the anomalies by the one or more machine learning algorithms employed by the anomaly detection module 1030. For example, when the normal usage of the computing resources may be wrongly identified as an anomaly and upon receiving feedback from the user, one or more machine learning algorithms are re-trained using the data corresponding to the usage pattern, thereby improving the identification of the anomaly's accuracy.

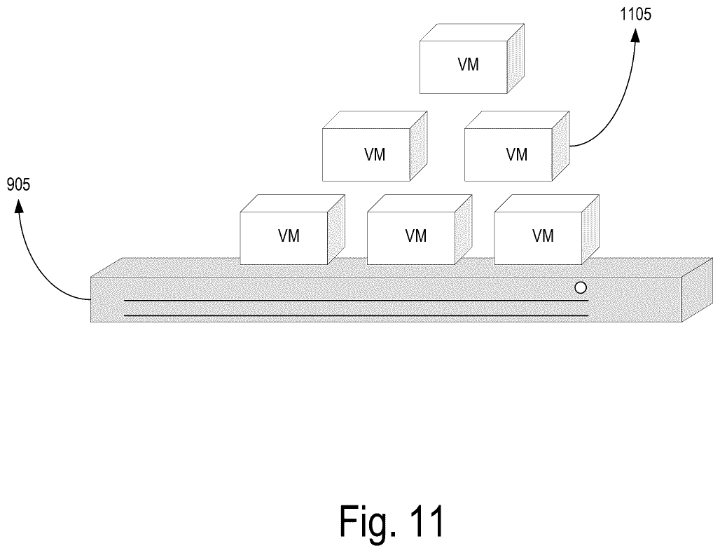

Referring to FIG. 11, FIG. 11 is a schematic illustration of the computing resources usage during normal activity. The fraud detection system 915 may initially receive a request from a user to register the user. Upon registering the user, the user may select a subscription plan based on the cloud resources required for the software application associated with the user. The fraud detection system 915 is then configured to allocate the computing resources to the one or more users based on the subscription plan. For example, the user may be an owner of a software company and may need the cloud resources (i.e., virtual machines 1105) so that the employees of the software company may use the cloud resources to develop one or more software applications.

As shown in FIG. 11, the computing resources such as virtual machines (VMs) 1105 are provided from the cloud service platform 905 for the user. Each VM represents a separate instance of a virtualized environment that the user may utilize for various computational tasks. The VMs may be dynamically created, managed, and terminated based on user requirements and the registration type of the user with the cloud service platform 905. By utilizing the VMs, the employees of the user may perform one or more software developmental activities. Further, the fraud detection system 915 may monitor the usage of the VMs and may identify that as the normal and expected usage of the cloud resources.

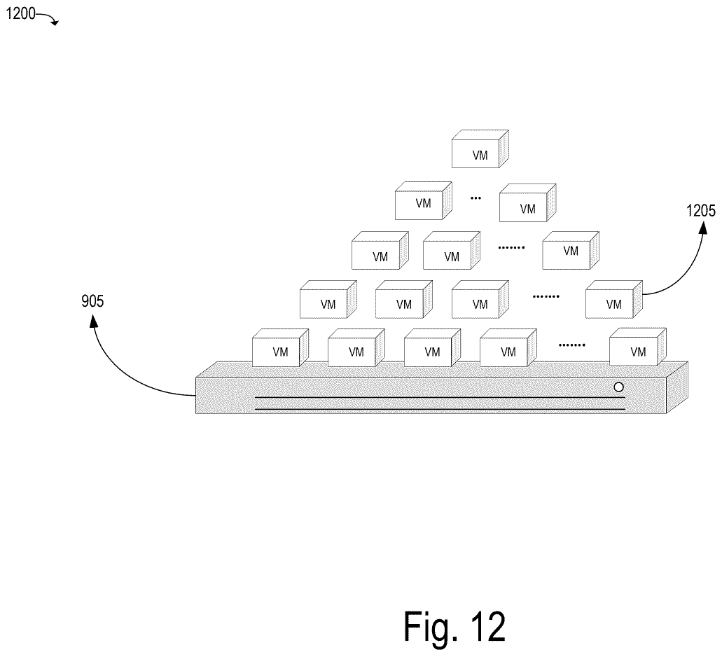

Referring to FIG. 12, FIG. 12 is a schematic illustration of the computing resources usage during unauthorized cryptocurrency mining activity. For the same example as explained with respect to FIG. 11, FIG. 12 depicts the cloud service platform 905 with a significantly higher number of virtual machines (VMs) 1205, suggesting abnormal and unauthorized activity. This increase in the number of VMs indicates that someone is exploiting the cloud resources for activities such as unauthorized cryptocurrency mining by deploying mining software on the VMs, which leads to excessive and unexpected consumption of processing power, electricity, and network bandwidth. The unauthorized cryptocurrency mining generally involves spinning up numerous VMs to perform intensive computational tasks required for mining. The rapid and large-scale creation of VMs, as depicted in FIG. 12, is a key indicator of unauthorized activity, which deviates significantly from normal usage.

Upon detecting such anomalies activities, the fraud detection system 915 may take appropriate actions, including suspending the VM instances to prevent further exploitation, generating alerts and reports to inform administrators of the suspicious activity, and implementing additional security measures to strengthen defenses against similar future attacks.

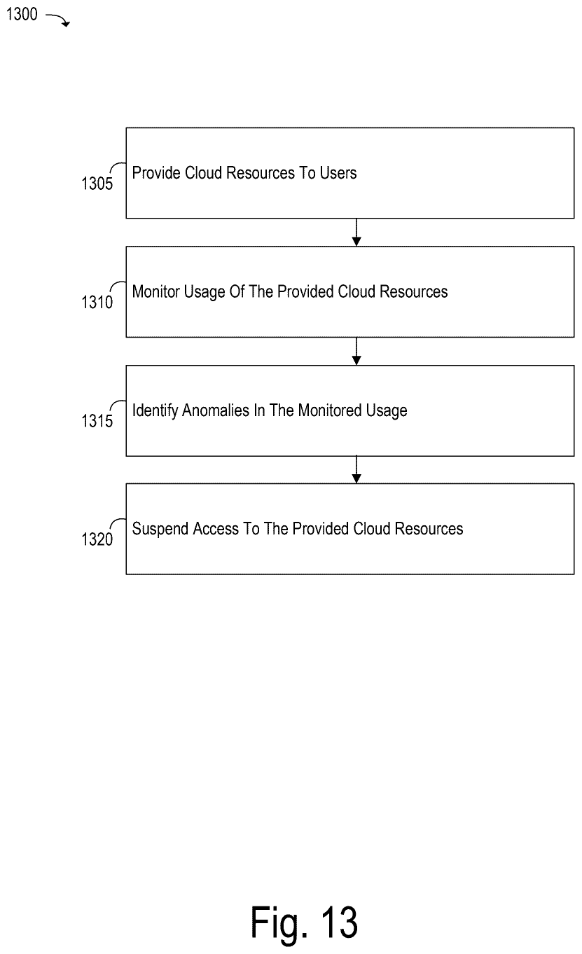

Referring to FIG. 13, FIG. 13 is a flow diagram for an embodiment of the disclosed subject matter for a process 1300 of detecting fraudulent activities on a cloud service platform.

At step 1305, the process 1300 may provide cloud resources to customers. In some embodiments, the cloud resources are provided to the customer by the cloud resource allocation module 1010. In order to provide the cloud resources, a request from one or more users is received to allocate the computing resources to the one or more users based. Upon receiving the request, the cloud resources are provided. In some embodiments, the cloud resources may comprise virtual machines, storage, network services, or the like.

At step 1310, the process 1300 may monitor usage of the provided cloud resources. In some embodiments, the usage of the provided cloud resources is monitored by the monitoring module 1020. In some embodiments, the usage of the cloud resources is continuously monitored upon the computing resources allocated to the one or more users. In some embodiments, the monitored cloud resource usage comprises CPU usage, memory usage, network bandwidth, and storage utilization. Further, in some embodiments, resource usage pattern is detected based on the monitored cloud resource usage.

At step 1315, the process 1300 may identify anomalies in the monitored usage based on a predefined threshold. The predefined threshold may be adjusted based on time of day, day of week, and customer usage profiles. For example, the predefined threshold of cloud storage may be 1 GB of cloud storage for normal working hours and may be adjusted to 500 MB after normal working hours. Similarly, the predefined threshold may be 1 GB of cloud storage for any user registered with the cloud service platform 905, whereas for one or more employees of the cloud service platform, the predefined threshold may be 100 GB of cloud storage. In some embodiments, one or more machine learning algorithms may be employed by the anomaly detection module 1030 are trained using historical data to resource usage patterns to detect the one or more anomalies.

In some embodiments, the one or more anomalies may comprise fraudulent activities on the computing resources allocated. Further, the fraudulent activities may comprise unauthorized cryptocurrency activities on the computing resource allocated. In some other embodiments, the one or more anomalies may comprise excessive resource consumption and abnormal access pattern.

At step 1320, the process 1300 may suspend access to the provided cloud resources based on the identified anomalies. In some embodiments, access to the provided cloud resources are suspended by the report generation module 1040 based on the identified anomalies.

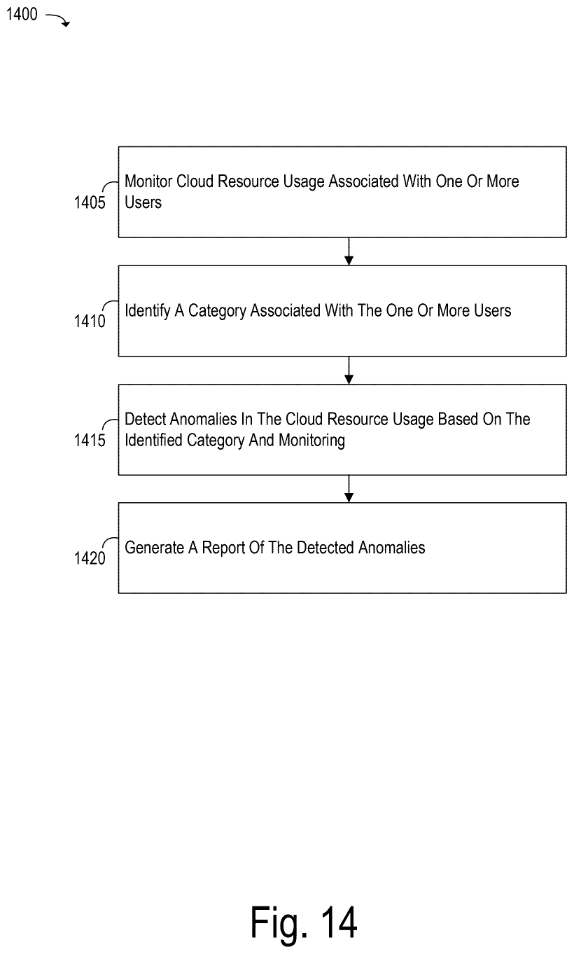

Referring to FIG. 14, FIG. 14 is a flow diagram for another embodiment of the disclosed subject matter for a process 1400 of detecting fraudulent activities on a cloud service platform.

At step 1405, the process 1400 may monitor cloud resource usage associated with one or more users. In some embodiments, the cloud resource usage associated with the one or more user may be monitored by the monitoring module 1020. In some embodiments, the usage of the cloud resources is continuously monitored upon the computing resources allocated to the one or more users.

At step 1410, the process 1400 may identify a category associated with the one or more users. In some embodiments, the category associated with the one or more users is identified by the monitoring module 1020. The category is identified by the monitoring module 1020 by retrieving the category (also known as user profile) from the database 910.

At step 1415, the process 1400 may detect anomalies in the cloud resource usage based on the monitoring and the identified category. In some embodiments, the anomalies in the cloud resource usage are detected by the anomaly detection module 1030 based on the monitoring and the identified category. In some embodiments, in order to detect the one or more anomalies, the monitored cloud resource usage is compared against a baseline usage and detect the one or more anomalies based on the comparison. In some embodiments, one or more machine learning algorithms trained using historical data to resource usage patterns are employed by the anomaly detection module 1030 to detect the one or more anomalies.

At step 1420, the process 1400 may generate a report of the detected anomalies. In some embodiments, the report is generated based on the detected anomalies by the report generation module 1040. In some embodiments, the generated report provides details such as the time of occurrence of the identified anomaly, type of anomaly, affected computing resources due to the identified anomaly, the user identification number using the computing resource when the anomaly is identified. In some embodiments, the report also comprises recommendations for mitigating the identified anomalies and for preventing future occurrences of the identified anomalies. Further, in some embodiments, one or more actions are executed based on the identified anomalies. In some embodiments, executing the one or more actions may comprise suspend access to cloud resources provided to the one or more users based on the identified anomalies. In some embodiments, executing the one or more actions may comprise restrict an access to cloud resources provided to the one or more users based on the identified anomalies. Furthermore, in some exemplary embodiments, inputs are received from the one or more users to revoke the executed one or more actions. In some embodiments, the inputs also comprise justification for the identified anomaly.

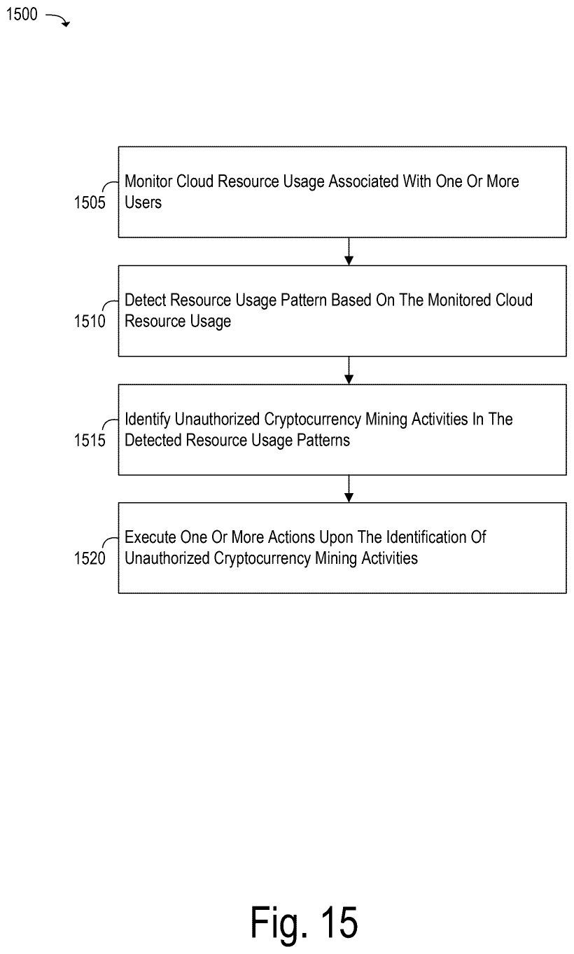

Referring to FIG. 15, FIG. 15 is a flow diagram for an embodiment of the disclosed subject matter for a process 1500 of preventing cryptocurrency mining fraud on a cloud service platform.

At step 1505, the process 1500 may monitor cloud resource usage associated with one or more users. In some embodiments, the cloud resource usage associated with the one or more user may be monitored by the monitoring module 1020. In some embodiments, the usage of the cloud resources is continuously monitored upon the computing resources allocated to the one or more users.

At step 1510, the process 1500 may detect resource usage pattern based on the monitored cloud resource usage. In some embodiments, resource usage pattern is detected based on the monitored cloud resource usage. For example, the user may subscribe to a cloud resource of 1 TB of data storage and may upload data of 100 MB every day. Thus, by monitoring the cloud resource usage, the pattern of usage, in this case uploading data for 100 MB, is detected.

At step 1515, the process 1500 may identify unauthorized cryptocurrency mining activities in the detected resource usage pattern. In some embodiments, the unauthorized cryptocurrency mining activities are identified by the anomaly detection module 1030 in the detected resource usage pattern.

At step 1520, the process 1500 may execute one or more actions upon the identification of unauthorized cryptocurrency mining activities. In some embodiments, one or more actions are executed by the report generation module 1040 based on the identification of unauthorized cryptocurrency mining activities. In some embodiments, executing the one or more actions may comprise suspend access to cloud resources provided to the one or more users based on the identified anomalies.

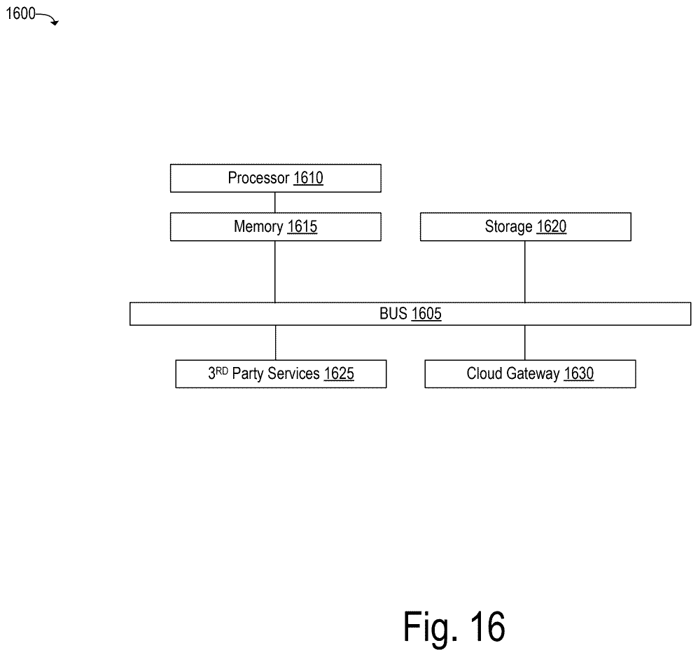

Referring to FIG. 16, FIG. 16 is a schematic illustrating a computing system 1600 that may be used to implement various features of embodiments described in the disclosed subject matter. The terms components, entities, modules, surface, and platform, when used herein, may refer to one of the many embodiments of a computing system 1600. The computing system 1600 may be a single computer, a co-located computing system, a cloud-based computing system, or the like. The computing system 1600 may be used to carry out the functions of one or more of the features, entities, and/or components of a software project.

The exemplary embodiment of the computing system 1600 shown in FIG. 16 includes a bus 1605 that connects the various components of the computing system 1600, one or more processors 1610 connected to a memory 1615, and at least one storage 1620. The processor 1610 is an electronic circuit that executes instructions that are passed to it from the memory 1615. Executed instructions are passed back from the processor 1610 to the memory 1615. The interaction between the processor 1610 and memory 1615 allow the computing system 1600 to perform computations, calculations, and various computing to run software applications.

Examples of the processor 1610 include central processing units (CPUs), graphics processing units (GPUs), field programmable gate arrays (FPGAs), complex programmable logic devices (CPLDs), and application specific integrated circuits (ASICs). The memory 1615 stores instructions that are to be passed to the processor 1610 and receives executed instructions from the processor 1610. The memory 1615 also passes and receives instructions from all other components of the computing system 1600 through the bus 1605. For example, a computer monitor may receive images from the memory 1615 for display. Examples of memory include random access memory (RAM) and read only memory (ROM). RAM has high speed memory retrieval and does not hold data after power is turned off. ROM is typically slower than RAM and does not lose data when power is turned off.

The storage 1620 is intended for long term data storage. Data in the software project such as computer readable specifications, code, designs, and the like may be saved in a storage 1620. The storage 1620 may be stored at any location including in the cloud. Various types of storage include spinning magnetic drives and solid-state storage drives.

The computing system 1600 may connect to other computing systems in the performance of a software project. For instance, the computing system 1600 may send and receive data from 3^{rd} party services such as Office 365 and Adobe. Similarly, users may access the computing system 1600 via a cloud gateway 1630. For instance, a user on a separate computing system may connect to the computing system 1600 to access data, interact with the run entities 108, and even use 3^{rd} party services 1625 via the cloud gateway.

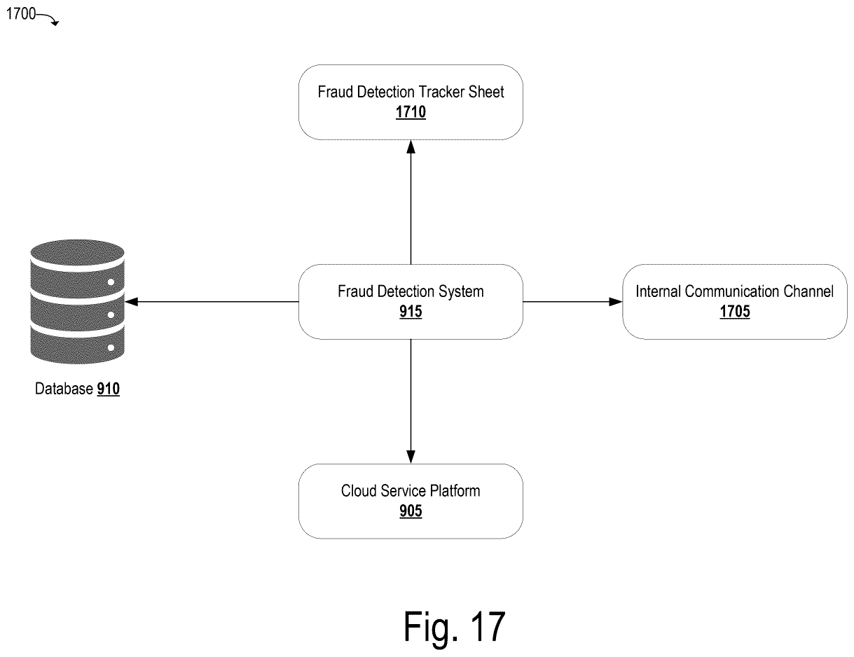

Referring to FIG. 17, FIG. 17 is a schematic illustration of an example of another embodiment using the fraud detection system 915. The illustration 1700 describes a schematic representation of the cloud service platform 905, the database 910, the fraud detection system 915, a fraud detection tracker sheet 1705, and an internal communication channel 1710. The illustration shows how different components (such as the cloud service platform 905, the database 910, the fraud detection tracker sheet 1705, and the internal communication channel 1710) interact with the fraud detection system 915. The cloud service platform 905 is configured to host a plurality of computing resources that may be required by one or more users to run software applications with ease. The cloud service platform 905 may register one or more users and provide the plurality of computing resources. In some embodiments, the computing resources are provided based on a subscription level selected by the one or more users upon registering to the cloud service platform 905. The information about the registered users and the subscription level associated with the registered users is stored in the database 910.

The fraud detection system 915 may allocate the computing resources to the one or more users based on user requirements, continuously monitor usage of the computing resources provided by the cloud service platform 905 to the one or more users, and analyze the usage of one or more computing resources to detect any fraudulent activity. If any fraudulent activity is found, the fraud detection system 915 may suspend the subscription of the user. Further, the fraud detection system 915 may enable the database 910 to store the information about suspending the subscription. Further, the fraud detection system 915 may append the information about suspending the subscription in the fraud detection tracker sheet 1705 through one or more Application Programming Interfaces (APIs). For example, the fraud detection tracker sheet 1705 may be Google Sheet.

Furthermore, the fraud detection system 915 may inform about any fraudulent activity to one or more team members through the internal communication channel 1710. For example, the internal communication channel may be Microsoft Teams, Skype, or Slack Webhook.

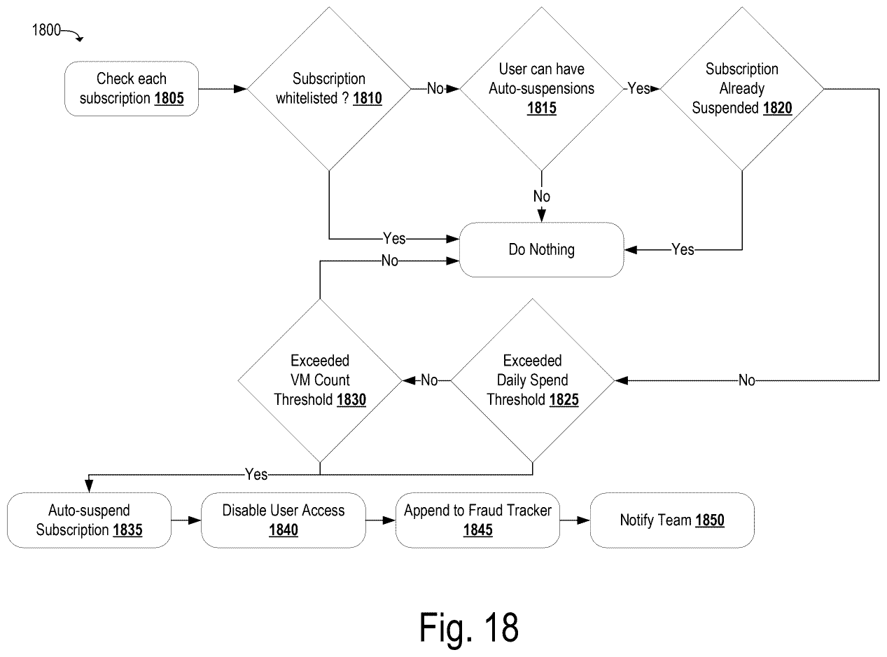

Referring to FIG. 18, FIG. 18 is a flow diagram for an embodiment of the disclosed subject matter for a process 1800 implemented by the fraud detection system 915. The process 1800 may be implemented in the fraud detection system 915 when monitoring the cloud resource usage allocated to one or more users. Initially, the fraud detection system 915 may check each subscription plan associated with the one or more users at step 1805. Upon checking the subscription plan, the fraud detection system 915 may determine whether the subscription is whitelisted or not at step 1810. If the subscription is not whitelisted, the fraud detection system 915 may determine whether the user is having auto-suspension or not at step 1815. If the user has auto-suspension, the fraud detection system 915 may determine whether the subscription is already suspended or not at step 1820.

If the subscription is not suspended, the fraud detection system 915 may determine whether the user daily spend limit threshold is exceeded or not at step 1825. If the user daily spend limit is not exceeded, the fraud detection system 915 may determine whether VM count threshold is exceeded or not at step 1830. If the VM count threshold is exceeded at step 1830 or the daily spend threshold is exceeded at step 1825, the fraud detection system 915 may auto-suspend the subscription at step 1835 and disable user access at step 1840.

Further, the fraud detection system 915 may append the details of auto-suspension to a fraud tracker at step 1845. Further, the fraud detection system 915 may also notify one or more team members about the auto-suspension at step 1850.

A method for detecting fraudulent activity on cloud resources includes providing the cloud resources to one or more users through the cloud service platform, monitoring usage of the provided cloud resources, identifying anomalies in the monitored usage based on predefined thresholds, and suspending access to the provided cloud resources based on the identified anomalies. The cloud resources provided to the one or more users may include virtual machines, storage, and network services. The method may further include notifying the one or more users when access to the provided cloud resources is suspended. Monitoring the usage may include collecting data on CPU usage, memory usage, network bandwidth, and storage utilization. Identifying the anomalies may include using machine learning algorithms trained on historical usage data to detect deviations from normal usage. The predefined thresholds may be adjusted based on the time of day, day of the week, and customer usage profiles. The identified anomalies may include unauthorized cryptocurrency mining, excessive resource consumption, and abnormal access patterns.

A computer system for detecting fraudulent activity on cloud resources includes a processor coupled to a memory. The processor is configured to execute software to provide the cloud resources to one or more users through the cloud service platform, monitor usage of the provided cloud resources, identify anomalies in the monitored usage based on predefined thresholds, and suspend access to the provided cloud resources based on the identified anomalies. The cloud resources provided to the one or more users may include virtual machines, storage, and network services. The processor may be further configured to notify the one or more users when access to the provided cloud resources is suspended. To monitor the usage, the processor may be configured to collect data on CPU usage, memory usage, network bandwidth, and storage utilization. To identify the anomalies, the processor may be configured to employ machine learning algorithms trained on historical usage data to detect deviations from normal usage. The processor may be configured to adjust the predefined thresholds based on the time of day, day of the week, and customer usage profiles. The identified anomalies may include unauthorized cryptocurrency mining, excessive resource consumption, and abnormal access patterns.

A computer-readable storage medium has data stored in it representing software executable by a computer. The software includes instructions that, when executed, cause the computer to provide the cloud resources to one or more users through the cloud service platform, monitor usage of the provided cloud resources, identify anomalies in the monitored usage based on predefined thresholds, and suspend access to the provided cloud resources based on the identified anomalies. The cloud resources provided to the one or more users may include virtual machines, storage, and network services. The software may further include notifying the one or more users when access to the provided cloud resources is suspended. Monitoring the usage may include collecting data on CPU usage, memory usage, network bandwidth, and storage utilization. Identifying the anomalies may include using machine learning algorithms trained on historical usage data to detect deviations from normal usage. The predefined thresholds may be adjusted based on the time of day, day of the week, and customer usage profiles.

A method for detecting anomalies in cloud resource usage includes monitoring the cloud resource usage associated with one or more users, identifying a category associated with the one or more users, detecting anomalies in the cloud resource usage based on the monitoring and the identified category, and generating a report of the detected anomalies. The method may include training machine learning algorithms using historical data to detect the anomalies in the cloud resource usage. Detecting the anomalies may include comparing the monitored cloud resource usage against an established baseline for the identified category. The generated report may include the time of occurrence of the detected anomalies, type of anomaly, affected resources due to the detected anomaly, and user identification number using the computing resource when the anomaly is identified. The method may further include suspending access to cloud resources for the one or more users. The generated report may include recommendations for mitigating the detected anomalies. The method may also include receiving feedback from the one or more users to improve the accuracy of the detection.

A computer system for detecting anomalies in cloud resource usage includes a processor coupled to a memory. The processor is configured to execute software to monitor the cloud resource usage associated with one or more users, identify a category associated with the one or more users, detect anomalies in the cloud resource usage based on the monitoring and the identified category, and generate a report of the detected anomalies. The processor may be configured to train machine learning algorithms using historical data to detect the anomalies in the cloud resource usage. To detect the anomalies, the processor may be configured to compare the monitored cloud resource usage against an established baseline for the identified category. The generated report may include the time of occurrence of the detected anomalies, type of anomaly, affected resources due to the detected anomaly, and user identification number using the computing resource when the anomaly is identified. The processor may be configured to suspend access to cloud resources for the one or more users. The generated report may include recommendations for mitigating the detected anomalies. The processor may be configured to receive feedback from the one or more users to improve the accuracy of the detection.

A computer-readable storage medium has data stored in it representing software executable by a computer. The software includes instructions that, when executed, cause the computer to monitor cloud resource usage associated with one or more users, identify a category associated with the one or more users, detect anomalies in the cloud resource usage based on the monitoring and the identified category, and generate a report of the detected anomalies. The software may include training machine learning algorithms using historical data to detect the anomalies in the cloud resource usage. Detecting the anomalies may include comparing the monitored cloud resource usage against an established baseline for the identified category. The generated report may include the time of occurrence of the detected anomalies, type of anomaly, affected resources due to the detected anomaly, and user identification number using the computing resource when the anomaly is identified. The software may further include suspending access to cloud resources for the one or more users. The generated report may include recommendations for mitigating the detected anomalies.

A method for preventing cryptocurrency mining fraud on a cloud service platform includes monitoring cloud resource usage associated with one or more users, detecting resource usage patterns based on the monitored cloud resource usage, identifying unauthorized cryptocurrency mining activities in the detected resource usage patterns, and executing one or more actions upon the identification of unauthorized cryptocurrency mining activities. The unauthorized cryptocurrency mining activities may be identified using trained detection algorithms, which are trained using historical data to recognize resource usage patterns characteristic of unauthorized cryptocurrency mining activities. Detecting the resource usage patterns may include analyzing the frequency, duration, and intensity of the cloud resource usage. Identifying the unauthorized cryptocurrency mining activities may include comparing the detected resource usage pattern against an established baseline. Executing the one or more actions may include suspending access to the cloud resources. The method may further include generating a report of the identified unauthorized cryptocurrency mining activities, where the generated report includes the time of occurrence, type of activity, affected resources, and user identification. The method may also include allowing the one or more users to revoke the executed one or more actions.

A computer system for preventing cryptocurrency mining fraud on a cloud service platform includes a processor coupled to a memory. The processor is configured to execute software to monitor cloud resource usage associated with one or more users, detect resource usage patterns based on the monitored cloud resource usage, identify unauthorized cryptocurrency mining activities in the detected resource usage patterns, and execute one or more actions upon the identification of unauthorized cryptocurrency mining activities. The processor may be configured to train detection algorithms to identify the unauthorized cryptocurrency mining activities, using historical data to recognize resource usage patterns characteristic of unauthorized cryptocurrency mining activities. To detect the resource usage pattern, the processor may be configured to analyze the frequency, duration, and intensity of the cloud resource usage. To identify the unauthorized cryptocurrency mining activities, the processor may be configured to compare the detected resource usage pattern against an established baseline. To execute the one or more actions, the processor may be configured to suspend access to cloud resources for the one or more users. The processor may be configured to generate a report of the identified unauthorized cryptocurrency mining activities, where the generated report includes the time of occurrence, type of activity, affected resources, and user identification. The processor may be further configured to allow the one or more users to revoke the executed one or more actions.

A computer-readable storage medium has data stored in it representing software executable by a computer. The software includes instructions that, when executed, cause the computer to monitor cloud resource usage associated with one or more users, detect resource usage patterns based on the monitored cloud resource usage, identify unauthorized cryptocurrency mining activities in the detected resource usage patterns, and execute one or more actions upon the identification of unauthorized cryptocurrency mining activities. The unauthorized cryptocurrency mining activities may be identified using trained detection algorithms, trained using historical data to recognize resource usage patterns characteristic of unauthorized cryptocurrency mining activities. Detecting the resource usage patterns may include analyzing the frequency, duration, and intensity of the cloud resource usage. Identifying the unauthorized cryptocurrency mining activities may include comparing the detected resource usage pattern against an established baseline. Executing the one or more actions may include suspending access to the cloud resources. The software may further include generating a report of the identified unauthorized cryptocurrency mining activities, where the generated report includes the time of occurrence, type of activity, affected resources, and user identification.

Many variations may be made to the embodiments of the software project described herein. All variations, including combinations of variations, are intended to be included within the scope of this disclosure. The description of the embodiments herein can be practiced in many ways. Any terminology used herein should not be construed as restricting the features or aspects of the disclosed subject matter. The scope should instead be construed in accordance with the appended claims.

1. A method for detecting fraudulent activity on cloud resources, comprising:
providing, through a cloud service platform, the cloud resources to one or more users;
monitoring usage of the provided cloud resources;
identifying anomalies in the monitored usage based on predefined thresholds; and
suspending access to the provided cloud resources based on the identified anomalies.

2. The method of claim 1, wherein the cloud resources provided to the one or more users include virtual machines, storage, and network services.

3. The method of claim 1, further comprising:
notifying the one or more users when the access to the provided cloud resources is suspended.

4. The method of claim 1, wherein monitoring the usage includes collecting data on CPU usage, memory usage, network bandwidth, and storage utilization.

5. The method of claim 1, wherein identifying the anomalies includes using machine learning algorithms trained on historical usage data to detect deviations from a normal usage.

6. The method of claim 1, wherein the predefined thresholds are adjusted based on a time of day, a day of week, and customer usage profiles.

7. The method of claim 1, wherein the identified anomalies include unauthorized cryptocurrency mining, excessive resource consumption, and abnormal access patterns.

8. A computer system to detect fraudulent activity on cloud resources, the computer system comprising:
a processor coupled to a memory, the processor configured to execute a software to perform:
provide, through a cloud service platform, the cloud resources to one or more users;
monitor a usage of the provided cloud resources;
identify anomalies in the monitored usage based on predefined thresholds; and
suspend access to the provided cloud resources based on the identified anomalies.

9. The computer system of claim 8, wherein the cloud resources provided to the one or more users include virtual machines, storage, and network services.

10. The computer system of claim 8, the processor is further configured to:
notify the one or more users when the access to the provided cloud resources is suspended.

11. The computer system of claim 8, wherein to monitor the usage, the processor is configured to collect data on CPU usage, memory usage, network bandwidth, and storage utilization.

12. The computer system of claim 8, wherein to identify the anomalies, the processor is configured to employ machine learning algorithms trained on historical usage data to detect deviations from a normal usage.

13. The computer system of claim 8, wherein the processor is configured to adjust the predefined thresholds based on a time of day, a day of week, and customer usage profiles.

14. The computer system of claim 8, wherein the identified anomalies include unauthorized cryptocurrency mining, excessive resource consumption, and abnormal access patterns.

15. A computer readable storage medium having data stored therein representing software executable by a computer, the software comprising instructions that, when executed, cause the computer readable storage medium to perform:
providing, through a cloud service platform, cloud resources to one or more users;
monitoring usage of the provided cloud resources;
identifying anomalies in the monitored usage based on predefined thresholds; and
suspending access to the provided cloud resources based on the identified anomalies.

16. The computer readable storage medium of claim 15, wherein the cloud resources provided to the one or more users include virtual machines, storage, and network services.

17. The computer readable storage medium of claim 15, further comprising:
notifying the one or more users when the access to the provided cloud resources is suspended.

18. The computer readable storage medium of claim 15, wherein monitoring the usage includes collecting data on CPU usage, memory usage, network bandwidth, and storage utilization.

19. The computer readable storage medium of claim 15, wherein identifying the anomalies includes using machine learning algorithms trained on historical usage data to detect deviations from a normal usage.

20. The computer readable storage medium of claim 15, wherein the predefined thresholds are adjusted based on a time of day, a day of week, and customer usage profiles.
